(19) United States
(12) Patent Application Publication
(10) Pub. No.: US 2002/0111996 A1
(43) Pub. Date: Aug. 15, 2002

(54) Method, system and apparatus for networking devices

(76) Inventors: David Jones, London (GB); Jeremy Richemont, London (GB); Jalal Sabzvari, London (GB)

Correspondence Address: SCHWEGMAN, LUNDBERG, WOESSNER & KLUTH, P.A., P.O. BOX 2938, MINNEAPOLIS, MN, 55402, US

(21) Appl. No.: 09/815,286

(22) Filed: Mar. 22, 2001

(30) Foreign Application Priority Data
Jan. 26, 2001 (GB) 0102116.1

(51) Int. Cl. G06F 15/16

(52) U.S. Cl. 709/203; 709/223

(57) ABSTRACT

A host for executing an operation requested by a requestor, the host comprising a memory configured to store information identifying the requestor and information related to the operation requested by the requestor, and processing means for determining the presence of the requestor and for deleting the operation and freeing resources associated with that operation if the requestor is not determined to be present and authenticated.

### FIELD OF INVENTION

The present invention relates to the field of networked devices such as computers, telephones or the like which are configured to send data over a synchronous or an asynchronous media such as the internet. In particular, the present invention relates to a method and system for establishing ‘virtual’ synchronous connections between anonymous devices connected over an asynchronous network.

### BACKGROUND OF THE INVENTION

The role of the internet for both private and commercial use is continually growing. The rapid expansion of communications technology which forms the backbone of the internet now makes it possible for more and more devices to be constantly connected to the internet via hardwire connections. Also, the increase in bandwidth of wireless connections now allows the connection of mobile devices such as mobile telephones, for example WAP phones, and Personal Digital Assistants (PDAs) to the internet.

A world where all machines capable of internet communication are permanently connected to the internet is not far away. However, the inherent asynchronous nature of the internet which provides poor security and reliability puts an obstacle in the way of such development.

FIG. 1 shows a typical communication route between a client 1001 which comprises a host computer 1003 running a client application 1005 and a server 1007 which comprises a second host computer 1009 running a server application o011. The client 1001 requests information from the server 1007. In order to do this, the client generates a data file 1013 which can be interpreted by the server 1007. The data file 1013 is divided into data packets 1015 in accordance with the protocol of the client's machine which in most cases will be TCP/IP (see for example UNIX Network Programming, Volume 1: Networking APIs—Sockets and XTI by: W. Richard Stevens; Prentice Hall; ISBN: 013490012X or UNIX Network Programming, Volume 2: Interprocess Communications by W. Richard Stevens; Prentice Hall; ISBN: 0130810819). These data packets carry information concerning their destination and how they are to be assembled at the destination. The data packets 1015 are then inserted into the internet stream of data 1017 and are then routed, via the internet 1019, to the server application 1011

The server opens a socket each time a new packet is received and closes the socket immediately after receipt of a single packet. The protocol associated with the remote host assembles the data 1021 back into a file 1023 and performs the task requested by the client application 1013.

However, this has problems because the client and the server are not in direct communication. The client 1001 does not know if the server 1007 has received the data file and the server 1007 does not know if the client 1001 is still present on the network. This can cause serious problems if the client suddenly dies. For example, if the client 1001 requests the server 1007 to open a file and dies before it requests a read operation, then the server is left with an open file and no means of knowing what to do next.

Further, with such asynchronous, anonymous communications, a later task cannot relate to an earlier one. Thus:

a) The client must hold all the state information on an ongoing application; and

b) The application must be amenable to such a division.

In other words, there is a need to establish a ‘session’ environment between two hosts across the internet, where the remote host which is performing the operations is continually aware of the local host and also where the remote host is aware of the history of the session during the session period (i.e. the continuous period during which the remote host is aware of the local host).

An attempt to partially solve one side of this problem has been made by the use of higher protocols which sit between the application layer and TCP/IP. These protocols take the file produced by the client 1001 and encode certain bits of information onto the file which allow the server 1007 to determine things about the file. For example, file transfer protocol (FTP), (see for example The official File Transfer Protocol specification rfco959, rfc1123, rfc2640 http://www.cis.ohio-state.edu/rfc/) keeps the receiving socket of the server open until an end of file message is reached. However, this protocol cannot check to see if the file has been completely received. Enhanced FTP (see for example: The official File Transfer Protocol specification rfc2389 http://www.cis.ohio-state.edu/rfc/) goes one step further and, if the network remains up, it checks to see if the whole file has been received and then closes the socket. Various other protocols are in existence that can keep the socket open until certain conditions are met or can categorise and prioritise packets.

The above methods all relate to a greater or lesser extent to monitoring the integrity of the file. However, none of them provide any means for checking if the client and server are still in contact after the successful communication of an application file from the client to the server.

This is not to say there is anything inherently wrong with existing file transfer mechanisms within their limitations provided that a socket is kept open for the duration of the transfer. Existing file transfer operations are undertaken in isolation in the sense that each transfer operation belongs to a particular session for a particular application and there is no means for referring to previous tasks performed.

Many of the major system providers in this area have provided systems which attempt to address communication over an asynchronous network. For example, Sun Microsystems' Jini system links a group of devices and software components to form a single dynamic distribution system called a federation. The services within this federation communicate with each other through a set of protocols implemented in Java and access to services is based on leases. (See for example: Core Jini, by: W. Keith Edwards, Prentice Hall; ISBN: 013014469X, The Jini™ Specification (The Jini™ Technology Series) by: Ken Arnold; Addison-Wesley Pub Co; ISBN: 0201616343 or the websites ‘The community resource for Jini technology at http://wwwjini.org/ or ‘Jini Planet’ at http://www.kedwards.com/.)

Microsoft WebDAV provides a system where files can be shared for both read and write access across the internet. (See for example the website ‘The community resources for WebDav technology’ at http://www.webdav.org.)

Groove from GrooveNet, copyrighted by IBM, is a combination of software and services that provides a peer-to-peer computing platform. It uses replication to provide a collaborative engine. See for example, the official website at http://www.groove.net.)

Also, so-called ‘session cookies’ are sometimes used by internet e-mail providers to get around the problem of accessing mail over an intermittent connection. These maintain a flag to show that the connection is still present. However, they work on a fixed time period. If the local host is connected for too long a time, then the session will be timed out. Similarly, if the local host finished the session, then it will not be able to log in again until the predetermined time of the previous session has elapsed.

### SUMMARY OF THE INVENTION

The present invention at least partially addresses the above problems concerned with establishing a session environment and, in a first aspect provides a host for executing an operation requested by a requestor, the host comprising a memory configured to store information identifying the requestor and information related to the operation requested by the requestor, and processing means for determining the presence of the requestor and for freeing resources associated with that operation if the requestor is not determined to be present.

For example, if the host has received a file open command, the host will have opened the file in anticipation of a read file or write file command. However, if the session between the requestor and the host has broken prior to read or write command being sent, then the host does not know what to do next.

In order to determine if the requestor is still present, the means to determine the presence of the requestor ideally comprises a timer and means to reset the timer on receipt of a refresh signal from the requestor, wherein if the refresh signal is not received within a predetermined time, the host terminates the operation or stores the state of the operation for recall.

Across a packet based network, the link between the requestor and the remote host may be broken for a small amount of time. Thus, broken links are tolerated and even expected provided the requestor re-establishes the link within a predetermined period of time.

Preferably but not exclusively, the above is implemented by configuring the host to store information identifying the requestor as an object, the host being provided with means to call a destructor function which will destroy the object and shut down the operation safely unless a refresh signal is received within a predetermined time from the requestor.

The object will generally comprise means to store a pointer pointing to status information relating to the operation of that object. The object also comprises a pointer pointing to the owner of the object.

The object may be created in response to a registration request by the requestor. As is the case with all ‘living objects’ (those whose continued existence depends upon receipt of a heartbeat) the owner is the requestor. If the object is created in response to a subsequent request by the requestor after registration, the object relating to this subsequent request is preferably owned by the registration object acting as proxy for the ultimate owner, the requestor, such that when the registration object is deleted, the objects owned by the registration object in its proxy role are also deleted and resources associated with these objects are freed.

All ‘living objects’ are owned by a registration object acting as proxy for a requestor. A client can only refresh its own objects; the registration object acting on its behalf achieves this. In addition, the registration object is also a living object and must be refreshed by the client who owns it.

The object can be thought of as being created by its parent (the requestor) in the remote host. The refresh signal from the parent keeps the object alive and can be thought of as a heartbeat.

The provision of a heartbeat between the requestor and remote host allows a ‘virtual’ synchronous session to be set up between the requestor and remote host. When such a ‘virtual’ session is established, the requestor and the host preferably keep listening on an agreed socket during the course of the ‘virtual’ session. The ‘virtual’ session is broken once the host fails to receive a refresh signal in time from the requestor. Thus, a ‘virtual’ synchronous session is provided which essentially provides a LAN-type arrangement.

Multiple requestors can each have such virtual synchronous sessions with the same remote host. However, it is also possible for a requestor for one operation to itself provide services for a further remote host or in response to a service request from the same remote host.

The present invention allows management of a quasi-synchronous session between the host and the requestor. If the session finishes, the host can free resources associated with the operations requested during the session. For example, where a file has been left open, the host can close the file. If the operation was to run a program, the program can be stopped and the host can be returned to its previous condition or a consistent state of operation.

For unreliable or intermittent network conditions such as mobile networks, a further state is invented where the state information becomes ‘embalmed’ or cached before being destroyed. For these conditions, if the requestor is not present due to network availability, the host can store the actual state information on disk or in memory, for future re-registration of the requestor and free open file descriptors, memory threads etc. Such conditions might arise using a mobile device, for example, when the requestor is travelling in and out of long tunnels or transferring large files to handheld mobile devices.

As previously mentioned, another important feature which defines a session is the ability to establish a history of the tasks performed during the session. Thus, in a second aspect, the present invention provides a host for executing a plurality of tasks in response to at least one request from a requestor, the host comprising a memory configured to store information identifying the requestor and information concerning the tasks such that information concerning the tasks can be preserved between tasks.

In a preferred arrangement, information concerning the identify of the requestor is stored in the form of a registration object in the memory of the host and wherein status information concerning each of the tasks is also stored in the form of objects in the memory of the host.

The registration object is preferably a ‘living object’ as previously described.

Preferably, the requestor is provided with means to publish web pages giving status information of the operations requested by the requestor or provide a link to one or more remote hosts for them to report their statuses. In the case of an internet technology application, the ability to generate web pages acts not just for status information, perhaps for systems administration staff and the like, but as the sole interface between the user and the application implemented via clerver technology.

The web pages may contain links to each of the remote hosts. However, if a remote host is not present, the web page can be published to indicate that this link is not available or not to show that link. This allows anyone with the correct security permissions to check the requestor's status.

Although such a tool is primarily intended for use with the above devices, the use of a device which can publish web pages from remote devices can also be of use in general. Thus, in a third aspect, the present invention provides a device comprising means to retrieve data from at least one other device, a web server configured to publish data concerning the status of the device, and means to check for the presence of the at least one second device, wherein the web server is configured to indicate if the second device is present.

In order to determine if the second device is present, the first device may be provided with a flag (status) which indicates that the second device is present.

This ability to provide synchronicity over an asynchronous network provides an ideal platform for peer-to-peer computing wherein at least some of the computers on a network have the ability to act as both clients and/or servers.

In order for the above devices to behave in the above described manner, they require a set of instructions. Thus, in a fourth aspect, the present invention provides a code module for controlling a local processor connected to one or more remote processors controlled by like code modules over a network, the code module being adapted to control the processor to communicate with a remote processor and to save information relating to a virtual session formed between the local and remote processors.

The code module (or ‘Clerver’ as it is often referred to) manages the session formed between the two processors, by saving information concerned with the virtual session such as the identity of the other code module and processor forming the session and the tasks requested during the session.

Information identifying the code module of the remote processor is preferably saved in the form of an object, which will be referred to as a registration object. The registration object persists for the duration of the session.

Once the session is finished, the code module preferably deletes the registration object and frees the resources associated with that object. The session can finish for a number of reasons. For example, the session may need to be terminated due to network problems. Thus, in order to overcome this problem, the code module creates the registration object such that it requires a signal from the code module of the remote processor after a predetermined time. If this signal is not received the session is terminated. Then the registration object is preferably deleted and the resources associated with the object are freed.

In many cases it is desirable for the code module to free all resources and delete any reference to the virtual session once the session has finished in order to free-up space and resources on the local host of the local processor. However, in some situations, it is desirable to retain some information about the session so that a new session can pick up from where the last session left off. Thus, it is preferable if the code module can store status information after the session has been terminated.

This ability to store status information between sessions is of particular use where the local processor and remote processor are connected over a volatile link. For example, if the remote processor is located in a mobile telephone or the like, the link will be broken if it is obstructed by a tunnel or when the mobile user enters into mobile free zones. In this situation, it is unlikely that the remote processor will be able to send the heartbeat to keep its registration object alive.

In order for the code module in the local host to terminate the session in this manner, it is preferable if the code module is adapted to distinguish between volatile connections and more robust connections. This can be done if the remote code module sends a flag to the local code module indicating if the connection is volatile.

The above discussion of the code module has centred on the how the virtual session is started and terminated. The remote processor will only require a session with the local processor if it wishes the local processor to perform certain tasks. In order to develop a true session environment, the code module is preferably adapted to manage a plurality of tasks requested by the remote code module in a single session and to store information concerning the tasks requested in a single session such that information from previously performed tasks is available for use by later tasks requested in the same session.

The information related to each requested task is preferably stored in the form of an object, wherein each object associated with a task is linked to the registration object. In order to preserve a session history which can be accessed by later tasks, an object relating to a task is preferably stored until the registration object has been deleted even if the task has been completed. The objects relating to tasks are deleted once the registration object has been or is going to be deleted.

Preferably, the code module is capable of managing a plurality of virtual sessions with a plurality of remote processors. Thus, the local code module should be adapted to store a plurality of registration objects each associated with a different remote code module. Each of the objects relating to a task requested by a remote code module is linked to the registration object of that control module.

In the above description, the local code module controls the processor to act as a server. However, the code module also preferably controls the processor to act as a client. Thus, the above code module is preferably also adapted to send information requesting a virtual session with a remote processor which is managed by a similar code module.

The above description has referred to the registration process; when a code module requests a registration with another such module it preferably sends information uniquely identifying the processor which it controls to the remote processor. For example it sends its HostID using UNIX terminology. However, there is no need for the HostID to be in the UNIX syntax. A plurality of such code modules may be provided on the same host. Thus, preferably, the code module is adapted to send information identifying itself to the remote processor when requesting a session.

On the basis of this information, a registration object can be formed in the remote host. The local code module sends a heartbeat to keep the object alive. Typically, the heartbeat signal will include information identifying the processor controlled by the local code module and the local code module itself.

The code module will generally be application specific and will be adapted to interface with a specific application. Typically, a code module will be supplied for each of applications provided on a host which require communication capabilities with a further processor. The code module may interface with an application which allows the host to act as a client and/or server.

To summarise, in a preferred system, a living object (an object that requires an intermittent heartbeat for its continued existence) called the ‘registration object’ is created on behalf of and owned by another ‘remote’ code module or clerver. All resources subsequently requested by or created as a consequence of that remote clerver's actions in interacting with the local code module or clerver can be registered in a way that is implementation-dependent with the registration object managed on behalf of the remote clerver.

Should that clerver fail to originate or produce a heartbeat within the accepted interval, the registration object can be given the responsibility for managing all objects registered with it (and so ‘belonging’ to the registration object's remote clerver) as they change from the ‘active and in use’ state to one of the ‘not active’ states. The disposition of these dependent objects is up to the application.

To implement this, a dependant object will supply a ‘destructor’ function as part of the process of becoming dependent—transient objects may be created during one request by the remote clerver which do not have to become dependent. However, any object that wishes to retain state from one request to the next must:

a) Do so on behalf of the remote clerver that requested it; and

b) Become dependent upon the continued existence of the remote clerver's proxy, the registration object.

The receipt of the heartbeat is required only by the registration object or proxy for that remote clerver. Heartbeats may be passed to dependent objects or other resources used by that remote clerver but the only requirement is that the remote clerver's proxy or ‘point of presence’ within this (local) clerver receives them.

In addition to the above, it is preferable if the code module also provides security. Thus preferably, the code module is adapted to interface to an encryption package which can encrypt or decrypt signals received from the code module.

In a preferred example, the signals are encrypted using information which uniquely identifies the processor which is controlled by the said code module and/or information which identifies the code module. This provides an extra layer of security as the remote code module will be able to identify the processor which sent the request.

The signals are also preferably encrypted using a time relating to when an operation was controlled by the code module—for example, when the signal was encrypted etc. This time can be sent to the remote code module and also allows a further check as the remote code module will be able to tell at what time the encrypted signal was ready for sending. If a long time has elapsed, then it might suggest that the signal had been intercepted.

The code module is preferably adapted to publish pages to the internet. This can be used as a user interface.

The above described code module manages a virtual session between a local processor and one or more remote processors. Thus, the code module requires some capability for sending and receiving signals. Preferably, the code module is adapted to interface directly to the socket layer of the processor. The code module has the facilities to manage the session and also provide encryption if required. Thus, the code module can provide a single entity which encapsulates both the application and the socket. This eliminates the need for open and proprietary protocols.

The code module will listen using a specific socket. This can be any socket. Preferably, the code module is adapted to switch sockets, for example, if a particular socket is busy or for security reasons.

Thus, a code module can be using almost any socket and also, a plurality of such code modules may all be running on the same host. For example, a code module may be provided for each application on the host. Thus, it is advantageous to have a code module which keeps track of the other code modules on the same machine. To avoid confusion, this will be referred to as the primary code module or ‘master clerver’, the other code modules will be referred to as secondary code modules. Such a primary code module will be adapted to store information about a plurality of further code modules all adapted to control the same processor. Typically, it will store the socket numbers used by each of the secondary code modules and also, preferably, the information concerning the applications which are interfaced to each of the plurality of further code modules.

Thus, if a local processor requires a service from a remote processor, it can contact the remote processor using the known socket used by the primary code module of the remote processor. The primary code module of the remote processor can then inform the code module of the local processor if such a service is available from the remote host and, if so, the socket number used by the desired code module.

Although each of the code modules may be connected to a different application, it may be advantageous for a plurality of code modules all to be connected to the same application. This is useful when an application may require a plurality of sessions with a plurality of different machines. For example, a plurality of code modules may be interfaced to a financial management application which requires multiple parallel sessions with the machines of a plurality of financial institutions e.g. banks, building societies, etc. Here a primary code module is used to keep a record of the secondary code modules interfaced to the application and also to keep a registry of their socket numbers.

The primary code module may have, but does not need to have all of the features of the above described modules. Thus, in a fifth aspect, the present invention provides a primary code module for controlling a processor to store information concerning at least one secondary code module wherein the at least one secondary code module is adapted to interface to a predetermined application and to manage a session formed between said processor and a remote processor. The primary code module will listen to a socket which should be known to all of the authorised processors on the network.

The primary code module itself may interface to an application. This application may also be interfaced to a secondary code module or it may be a separate application.

Other implementations might designate particular or specific living objects to manage heartbeats on behalf of single or multiple clervers. Potentially, depending on the application(s) involved, a living object might undertake such tasks for all the heartbeats for all the living objects for all the clervers on a given device.

In a sixth aspect, the present invention provides a carrier medium carrying a processor readable code module as described above. The carrier medium may be a signal, disc, CD-ROM, DVD, hardisk etc.

Code modules may be configured so that they can be downloaded from another device.

In a seventh aspect, the present invention provides a plurality of networked devices each comprising any of the above described code modules.

The above description has concentrated on how the present invention actually works and its preferred embodiments. The following illustrate systems which arise out of the above or known systems which are improved by the above.

The above hosts and code modules provide a perfect platform for running distributed applications. Such applications can run in a collaborative or a co-operative mode. In a collaborative mode, each clerver will share a single logical entity and each clerver will run its application consecutively. This is similar to how IBM's Lotus Notes operates. In general, replication is used to enable multiple users to collaborate in a sequential manner on a single piece of data. Only one person can manipulate the data at one time and ownership is sequential.

In a co-operative mode, separate sub-applications run on several separate machines which co-operate together to achieve a desired result. No one machine is able to do all the work so it co-operates with other machines.

For example, such a distributed environment could be used to solve the problems associated with managing distributed generic workflow amongst internet users. Although it is known how to manage workflow using proprietary main-frame systems, providing an accepted solution outside the boundaries of the corporate network is virtually impossible. A company having its own LAN will retain the files on a single server and each file is called by a device for editing or updating. However, the file remains on the server all the time. The reason for this is that other devices on the LAN cannot tell the details of the status of the file if it is located on another device.

Thus, in an eighth aspect, the present invention provides a method of sharing data files between a number of devices, the files being stored in a distributed manner amongst any number of the devices, wherein metadata containing at least the location of the files provided to be read by any of the devices with the appropriate access rights.

Metadata is a very powerful tool as it allows the location of the file to be known. The metadata may be stored on all or some of the devices. More preferably, the metadata is stored on a single device; even more preferably it is stored on a single device which does not store any of the shared files. Such a device will typically be referred to as a registry.

The above method benefits from the use of clervers as clervers allow a virtual session to be established and hence allow real-time updating of the metadata as each device can establish a virtual permanent session with the device holding the metadata.

Typically, when a new device comes onto the network, it will register with the registry and update the metadata held by the registry with information concerning the files stored on that device. The metadata does not only have to be the file location. The metadata can also include information concerning attributes, the registry being adapted to distinguish between files having different attributes such that the registry can supply information concerning just the files with a specific attribute.

For example, the files in question may relate to advertisements, the registry storing the information concerning the type of advertisement as well as its location, the registry also being able to distinguish between different types of advertisements such that the locations of advertisements of the same type can be retained in response to an enquiry requesting a certain type of advertisement.

Thus, if a user wishes to buy a bicycle, he can contact the registry and request details of advertisements relating to bicycles. The registry can then search through the files and identify the ones whose attributes indicate that they are for bicycles. The advertisements themselves would not be kept at the registry as it is unlikely that this information could be kept reliably up to date. The registry only has the file locations which will link back to the vendors' computers, (i.e. bicycle shops or advertisement service providers for bicycle shops). These should be up to date. The registry can then either send details of these file locations to the user's machine so that it can retrieve these files or it will contact the relevant vendor's machines and instruct them to send the files to the user.

Preferably, the above described code modules are used to manage the sessions formed between the machines, e.g. the registry to the vendor's machines or the user's machine to the registry or vendors' machines.

In many systems, file transfer of some form or another is required. Thus, in a ninth aspect, the present invention provides a method for transferring files from a first device to a second device, the method comprising: the first device interrogating a registry device with which the second device will register if it is able to receive the file; the first device sending a request to register with said second device and to establish a virtual session if the second device is able to receive the file; and sending the file to the second device.

The file can be sent to the registry if the second device cannot receive the file at the current time. For example, the second device may not be able to receive the file if it is off-line or if it does not wish to receive the file, e.g. if it does not recognise the first device or if it has insufficient storage capacity.

The above method is useful for sending e-mail. In known systems of sending e-mail, the first device will send the e-mail to its server which will in turn send the mail to the e-mail server of the second device. In the above system, the second device registers with the registry if it can receive e-mail. The first device checks with the registry to see if the second device can receive mail and sends the mail directly to the second device if it can. Thus, there is no need for the mail to sit on a server unless the second device cannot receive mail. The first device may be able to tell from the registry if this is the case and can decide whether or not to send the mail.

The above is enhanced by the use of clervers as it is possible to form managed virtual sessions between each of the devices involved in the mail transfer. Also, when the first device sends mail direct to the second device it can request other services from the second device to ensure that the mail has been safely received. For example, the first device might request an impression of the inbox of the second device to ensure that the mail is sitting in the in-box waiting to be read.

The above is not limited to the use of e-mail. For example, it can be applied to any system where files need to be transferred between different devices.

The code modules can listen on a required socket. Also, a local code module and a remote code module can negotiate with one another to change sockets. This provides a particularly secure file transfer technique as an eavesdropper will need to listen on every socket in order to listen to the whole file.

Thus, in a tenth aspect, the present invention provides a method of transferring files from a first device to a second device, each device being provided with the above described code modules, wherein the code module of the first device and the code module of the second device negotiate with one another to switch sockets during transfer of the file.

Preferably, the first device subdivides the file to be transferred into portions of data. The sockets are changed between the transmission of each portion. Each portion may then contain information which indicates the socket of the following portion.

The first device may also subdivide the file into portions of different sizes. Details of the size of each portion may be sent with each portion or with the preceding or following portion or portions. The type of encryption used may also be changed from portion to portion. An order of transmission may be attached to each portion and the portions may be transmitted in such a specified non-linear order to be reassembled by the receiving device.

The above described devices and code also lend themselves to a particularly secure communication method. Thus, in a eleventh aspect, the present invention provides a communication method between a first device and a second device, comprising the step of:

the second device receiving a registration request from the first device, the registration request comprising information uniquely identifying the first device.

For example, if the first device is a UNIX box, the HostID of the processor is required for registration.

This allows the second device to check to see if the registration request came from a device to which the second device can provide services.

For example, if the transaction is a sales transaction, and the second device is adapted to perform a step in a sales transaction requested by the first device, the second device can check to see if the first device has been used in a previous fraudulent transaction.

If the first device has been used with a stolen credit card number, then its HostID or equivalent can be sent to a registry where a blacklist of such devices is held. If the device later tries to make a transaction using a different credit card then the transaction can be refused and the owner of that credit card contacted to see if they had legitimately attempted to make that transaction or to see if the card has been stolen, but not yet reported missing. Also, a user whose credit or debit card has been stolen can protect his card from being used fraudulently by registering the HostID (or equivalent) of the devices which he will use. Thus, if this card is used with a different HostID to those registered, then the transaction can be refused and the HostID of the suspect machine recorded for further investigation.

Preferably, both of the first and second devices have code modules as previously described. A preferred adaptation of such modules requires information concerning the HostID or the like to be intermittently sent to its registration object, this makes it difficult for the HostID (or equivalent) of the device to be spoofed.

Clervers support different modes of transactions, including a one-to-many transaction mode known as ‘publish and subscribe’. This refers to many devices listening over a network for data being made available by a single device subject to authentication and authority levels. Publish and subscribe is a well-established technique in corporate or enterprise networks where authentication and authority levels are under proprietary control. However, it has not been possible to adapt publish and subscribe software satisfactorily to internet technologies because, although in a sense all web transactions are publish and subscribe, they are entirely open. It has not been possible to provide within internet technologies effective inbuilt authentication and management of authorities. This means that it is hard to make data sitting on legacy equipment directly available to authorised devices across the internet, the web or mobile networks.

Thus, in a twelfth aspect, the present invention provides a plurality of devices connected over a common network, each device comprising one of the above described code modules and being able to access data files on at least one of the other devices, wherein at least one of the devices has a web server responsive to authorised access requests to output selected data files as web pages.

Clervers can also be implemented across a network in such a way as to provide protection of the intellectual property rights of authors, publishers and others with rights to digital content, including digital audio and music content, digital text, digital video, digital still images, digital animation, digital software, and any digital combination of different forms of intellectual property.

This arises because of the way in which clervers enable encrypted licenses and encrypted usage information to be embodied within the same file that contains the intellectual property and for the licensing mechanisms to be managed and modified on-the-fly by clervers resident in the publishing and consuming devices.

Clerver technologies enable a publisher, author or owner of intellectual property to control on which device or devices his content can be used, and to specify for what period or periods of time any license should operate, and to specify predetermined numbers of discrete uses of the intellectual property, and to specify varying payment terms for varying uses of the intellectual property, and to enable such restrictions to be enforced.

Thus, in a thirteenth aspect, the present invention provides a method of leasing file content to a remote device, the method comprising the steps of:

the lessor receiving a request from a remote device indicating that the device wishes to lease at least some file content,

the lessor receiving information identifying the file content to be leased, information uniquely identifying the device requesting the lease and indicating the required extent of the lease;

the lessor packaging the requested file content with information uniquely identifying the user and indicating the extent of the lease to form a packaged file; and

executing the packaged file such that the file content is delivered to the remote device.

There is generally a need for there to be some means for measuring how much of the lease has been used. Thus, preferably, the requested file content is packaged with code which allows usage of the file content by the remote device to be monitored by the lessor. The code can manage the lease in terms of the number of times the file is used and/or the duration of use of the file. The second of these options is particularly useful when the above is used for pay-per-view or pay-per-use type applications.

The charge for the lease can be paid via a credit/debit card using known or any of the above described methods.

In order to provide security, the packaged file should be encrypted.

The packaged file may be executed on the remote device or it may be executed in a distributed manner between the remote device and other devices, for example, the lessor's device. The file content may be sent in its entirety to the remote device or it may be streamed to the remote device as required. The code which allows usage of the file by the remote device to be monitored by the lessor may be executed remote from the remote device.

The file may be packaged with a user identifier, the user identifier comprising information which uniquely identifies the remote device, information which identifies the requested file content and information which identifies a code module running on the remote device which communicates with the lessor. The user identifier may also comprise temporal information.

It is envisaged, that in a working system, a registration process between the lessor and the remote device will be performed. In this type of system, the date and time of registration may be used as the above referred to temporal information.

The optimum environment for this type of system is provided by the above described code modules. Thus, the lessor is preferably provided with such a code module. The lessor may be configured to send such a code module to the remote device as part of the registration procedure.

The system may also be configured to lease file content to a plurality of devices on the same lease. Here, each of the devices will be provided with such code modules.

The explanations and examples accompanying this description assume applications requiring a clerver safely to provide services to other clervers. The living objects those other clervers maintain are for safe removal of resources and authentication within the service-providing clerver.

But applications could be designed from an opposite point of view. A living object contains data relevant to the clerver that owns it. But the potential of a clerver does not stop there. The living object is accessible to the clerver within which it resides and an application could be designed in such a manner that the data the living object contains was relevant to it. An application could even be designed such that having access to the data in the living object it maintains was the sole reason for the remote clerver to maintain the living object in the first place.

In this style of implementation, the ‘service-providing’ clerver would in fact be the heart of the application and the ‘clients’ would be more agents for it. An application might be designed whereby a collection of remote clerver ‘agents’ maintain information within the so-called ‘service-provider’ clerver for the ‘service-provider's clerver's own use.

An example might be a systems monitoring application. Currently there exist applications such as Patrol from BMC Software in which a central process calls up many remote processes for status reports. If a systems monitoring application was built using clervers, each remote clerver could maintain its view on status within a set of living objects in the central clerver. The remote clervers would be calling on a service provided by the central clerver—for example, update my status object with this data—but the service would be of no use to them. Rather, the central clerver could access the data about status held within each remote's living object and provide a report to a human.

Directory ‘watching’ could be done in this manner. Instead of a central ‘client’ calling upon the services of many ‘servers’ with the ‘what's new’ request, we would have many clients calling on the ‘update my data’ service of one server. Information on directory content would be maintained entirely by the remote clervers, but the ‘service provider’ has access to all of these; indeed, that would be why the data was there at all—the central clerver would have asked the remote ones to provide it.

In such a configuration we would have a central clerver both as client requesting the ‘monitor this folder’ service on many remote servers and as server honouring the ‘update my list’ service request from many remote clients.

The above description has used the internet to explain the advantages of the present invention. However, it will be apparent to those skilled in the art that the present invention can be implemented on any fixed or mobile devices that are capable of being uniquely addressed across any network or media irrespective of the communication layer protocols. For example: intranet, extranet, phone-to-phone communication, general packet radio, digital television etc.

### BRIEF DESCRIPTION OF THE DRAWINGS

The present invention will now be described with reference to the following preferred non-limiting embodiments, in which:

FIG. 1 is a schematic diagram illustrating communication between a client and a server via the internet;

FIG. 2 is a schematic diagram of a local clerver communicating with a remote clerver in accordance with an embodiment of the present invention;

FIG. 3 is an overview of the registration steps which a local clerver performs in order to register with a remote clerver;

FIG. 4 is a flowchart of the steps which a local clerver performs when registering with a remote clerver;

FIG. 5 is a flowchart of the steps which a remote clerver performs in order to register a local clerver;

FIG. 6 is a schematic of how the remote clerver manages the registration procedure and requests from a local clerver;

FIG. 7 is a flow diagram of the steps which a local clerver takes in order to keep its registration alive at the remote clerver;

FIG. 8 is a flow diagram of the steps taken by the local and remote clervers to keep a living object alive;

FIG. 9 shows the basic structure of a clerver code module in accordance with an embodiment of the present invention;

FIG. 10a shows a layer structure of the protocol stack of a standard server, and FIG. 10b shows the equivalent for the clerver of FIG. 9;

FIG. 11 shows an overview of peer to peer computing;

FIG. 12 shows a distributed application environment created by a peer-to-peer network and publishing to the Web in accordance with an embodiment of the present invention;

FIG. 13 shows a distributed email environment created by a peer-to-peer network in accordance with an embodiment of the present invention;

FIG. 14 shows a schematic of a further embodiment of the present invention;

FIG. 15 illustrates an ecommerce application using a network of devices in accordance with an embodiment of the present invention;

FIG. 16 illustrates the security benefits of a network using devices in accordance with an embodiment of the present invention;

FIG. 17 illustrates a file transfer method between two devices incorporating code modules in accordance with an embodiment of the present invention;

FIG. 18 illustrates a method of delivering selected web advertisements in accordance with an embodiment of the present invention;

FIG. 19 illustrates a variation on the method of FIG. 18;

FIG. 20 illustrates a method for tracking stolen credit card numbers;

FIG. 21 illustrates a collaborative game playing method in accordance with an embodiment of the present invention;

FIGS. 22a, 22b, 22c illustrate discovery services provided by master clervers in accordance with an embodiment of the present invention;

FIG. 23 illustrates a plurality of devices, clervers and living objects in accordance with an embodiment of the present invention;

FIG. 24 illustrates new types of applications that can be supported in accordance with an embodiment of the present invention; and

FIG. 25 illustrates how publish and subscribe transactions are supported in accordance with an embodiment of the present invention;

FIG. 26 illustrates a pay-per-view/use system in accordance with an embodiment of the present invention; and

FIG. 27 illustrates a file structure for use with the system of FIG. 26.

### DESCRIPTION OF THE PREFERRED EMBODIMENTS

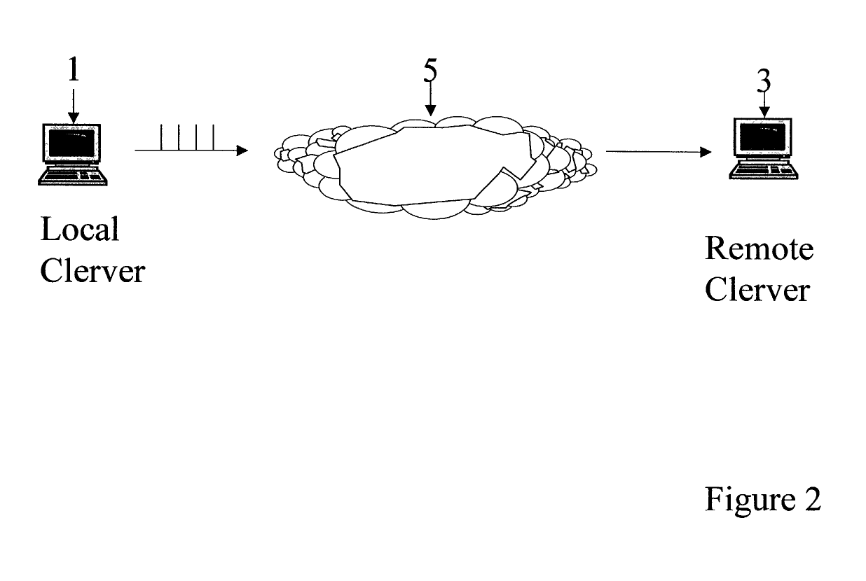

FIG. 2 schematically illustrates a session between two devices in accordance with an embodiment of the present invention.

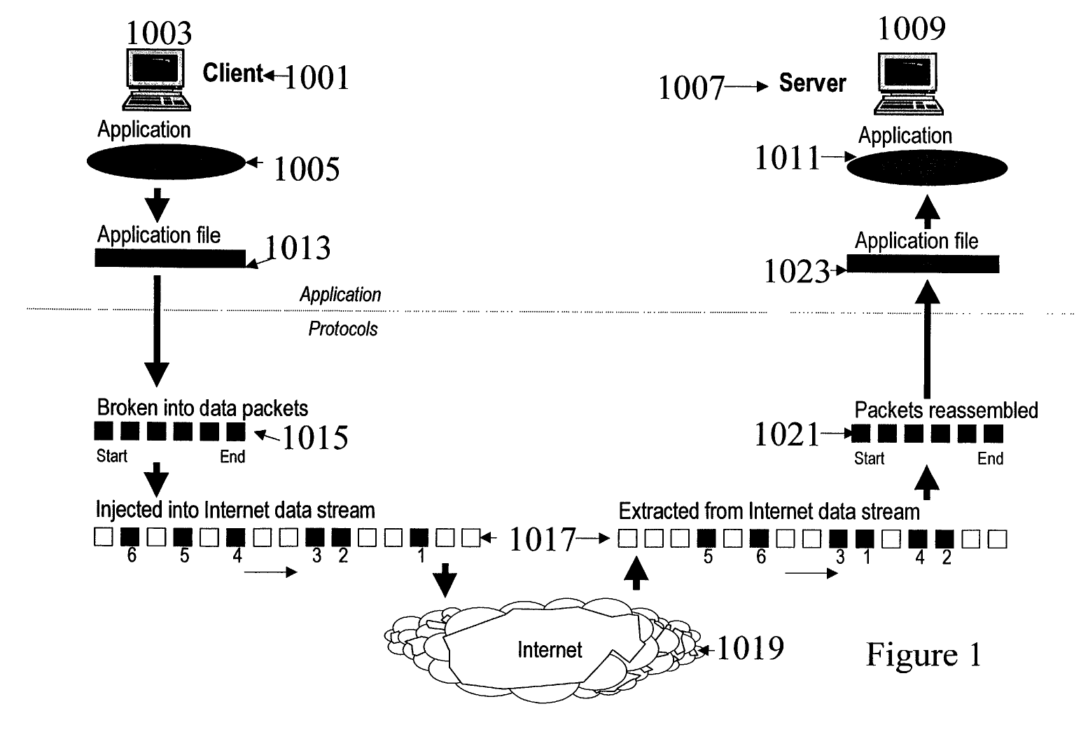

In FIG. 1, communication is shown between a client and a server. In the present invention, there is no need to designate hosts as being confined to just one role. Instead, hosts can run an application which allows them to perform as both a client and a server, sometimes at the same time. Thus, to emphasise this dual functionality, hosts will be referred to as clervers (=client and server). It should be noted at this stage that the clerver is not actually the machine itself, but is a code module which causes the host machine to behave in a certain way.

In FIG. 2 there are two clervers; in this specified example, one clerver will request the other clerver to perform a task. To avoid confusion in this example, the requesting clerver will be referred to as the “local” clerver and the clerver which performs the task will be referred to as the “remote” clerver.

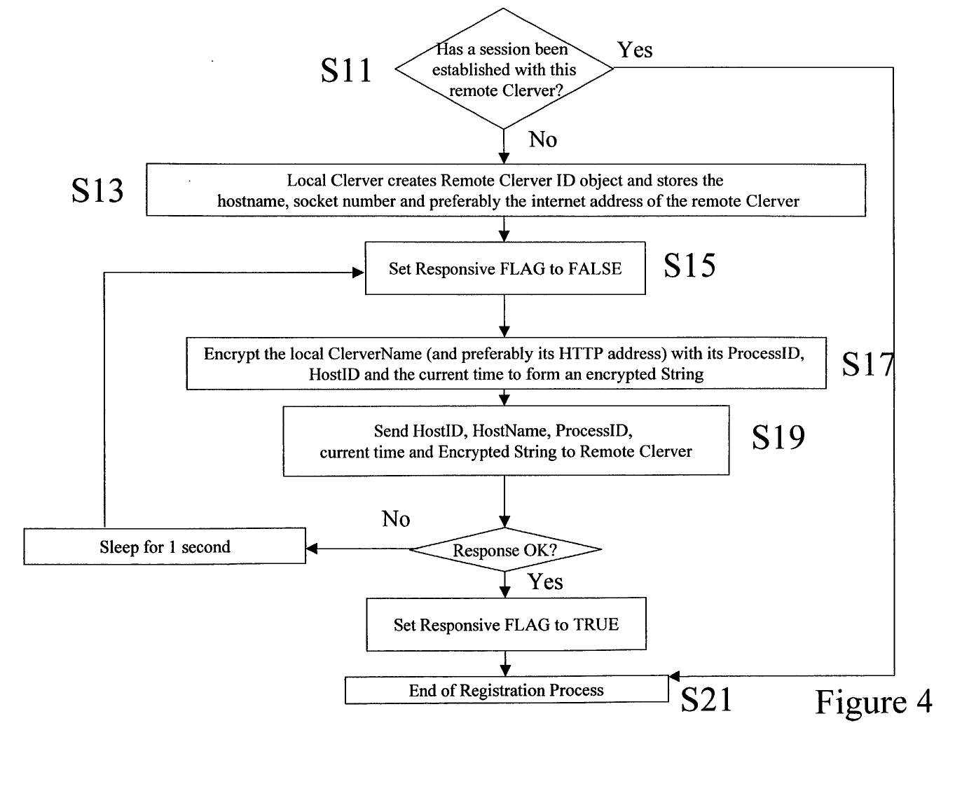

In FIG. 2, local clerver 1 requests a service to be run on remote clerver 3. The request is sent to the remote clerver 3 through the internet 5. In order for the remote clerver 3 to provide a service for the local clerver 1, the local clerver must first register with the remote clerver 3. The remote clerver creates an object (which will be described in detail with reference to FIGS. 4 to 6) which will be deleted if it does not receive a signal at a predetermined frequency (or higher) by the local clerver 1. This signal can be thought of as a heartbeat which the object created in the remote clerver requires in order to keep alive. Since the object dies without the sustenance of this parental heartbeat, the object is referred to as a living object.

In a typical situation, the object created in remote clerver 3 is owned by the local clerver 1. This object requires a heartbeat, say every 10 seconds. The local clerver 1 will attempt to send a heartbeat to the remote clerver every second. Thus, the object located in the remote clerver does not die if there is only a temporary blip in the “connection” between the local 1 and remote 3 clervers. The predetermined termination period and the frequency of the heartbeat can be adjusted to satisfy any network condition including mobile and other networks.

When the local clerver 1 is sending a heartbeat to the remote clerver 3 and the remote clerver is receiving such heartbeats, the local 1 and remote 3 clervers have a pseudosynchronous session formed between them.

If contact is lost, the local clerver 1 will be notified such that it can preserve state information about the progress of the requested job on the remote clerver 3. If the remote object does not receive its heartbeat, the object is deleted and resources are freed on the remote clerver. If contact is resumed, then the local clerver 1 can instruct the remote clerver 3 to restart the job from a specified point.

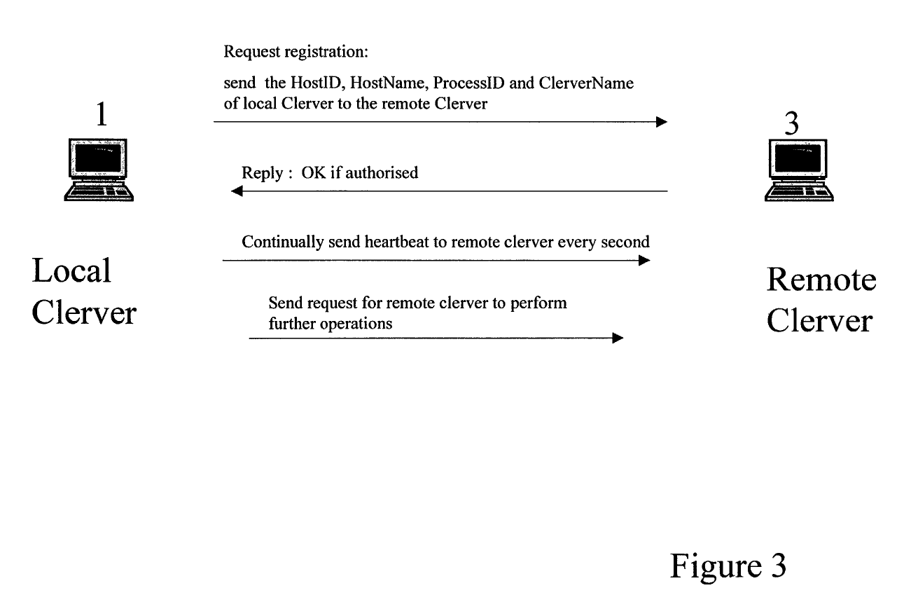

FIG. 3 shows an overview of the registration process which allows a session to be set up between the local clerver 1 and remote clerver 3. Initially, the local clerver sends a registration request to the remote clerver 3. The registration request comprises the HostID, ProcessID, HostName and ClerverName of the local clerver 1.

The HostID is the unique identity of the machine (including computer, mobile, Personal Digital Assistant (PDA)or other) which is referred to as of the machine hosting the local clerver. Although the name HostID is used it does not have to be in UNIX syntax. The HostID is a unique number which is different for every machine or computer in the world. The HostName is the name which the user has given to the host running the local clerver 1. The ProcessID is the unique identity for the local clerver over its lifetime (again, although the term ProcessID is used, it does not have to be in UNIX syntax); if the clerver is stopped and restarted, it will have a different Process ID, but if it registers and then reregisters with another clerver the ProcessID will the same. The ClerverName is a string used to easily identify the local clerver during the session.

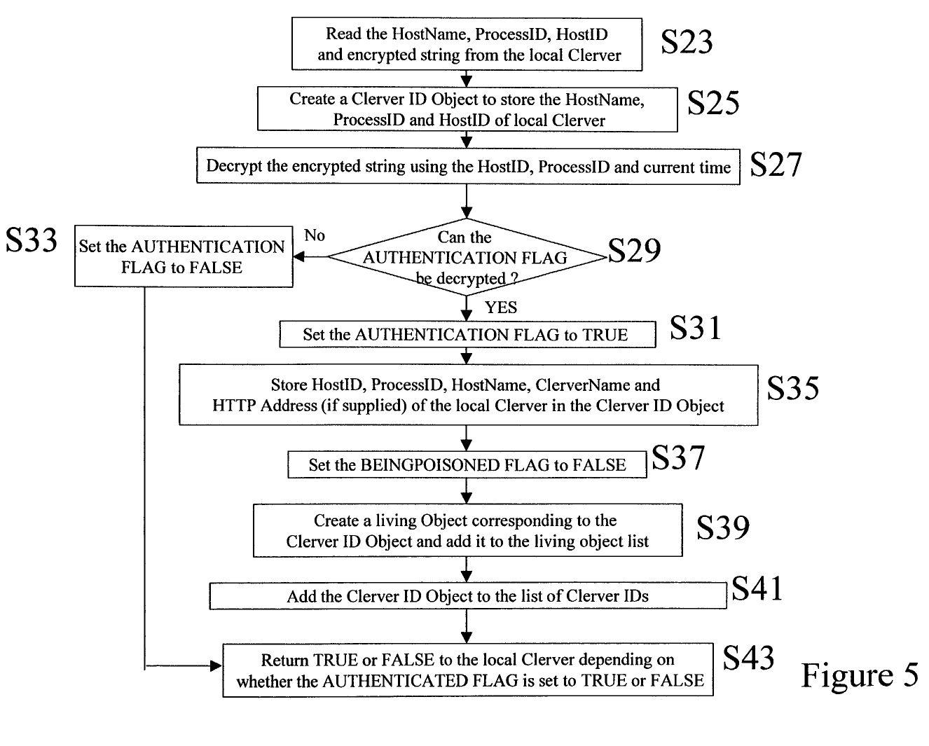

At least a part of the information sent with the registration request will be encrypted. Details of the encryption will be described with reference to FIGS. 4 and 5. If the remote clerver 3 accepts the registration request, then it will reply to the local clerver 1 to confirm that the registration request has been accepted.

The local clerver 1 then continually sends a reset signal or heartbeat at a predetermined frequency, say every second, to the remote clerver 3. Once this registration process is completed, the local clerver 1 sends requests to the remote clerver 3 to perform operations such as opening a file, reading a file, closing a file, running application programmes etc.

FIG. 4 is a flowchart showing the registration process from the side of the local clerver in more detail. At the start of the registration process, the local clerver first checks in step S11 if it already has a session with the remote clerver 3.

The memory of the local clerver stores a Unique Server list containing the details of each of the remote clervers with which it has established a session. The details of each remote clerver are stored in a Remote Clerver ID object.

The Local Clerver first checks to see if there are any remote clerver ID objects in the Unique Server list. If there is such an object, it compares the internet address, server name and socket numbers of the remote clerver with that of the first object in the Unique Server ID list. It then systematically goes through the list until it finds a match.

If a match is found, then the registration process has finished, step S21, because it is already registered.

If no match is found, then a new remote Clerver ID object is created which stores the internet address, socket number and the HostName (i.e. the name of the machine which the remote clerver runs on) in step S13.

In step S15, the local clerver changes its responsive flag for this particular server ID object to false. The responsive flag indicates if a response has been received from the remote clerver. The local clerver then prepares the registration request to send to the remote clerver in step S17. Here, the local ClerverName is encrypted using the HostID and ProcessID of the local clerver and also the current time.

The HTTP address of the local clerver may also be encrypted to send to the remote clerver. If the HTTP address is sent to the remote clerver, the web server of the remote clerver can reference the web pages served by the local clerver.

In step S19, the HostID, ProcessID, HostName and encrypted string formed in step S17 are then sent to the remote clerver. If a response is received from the remote clerver, an infinitely looping thread is started (Clotho client-side), the responsive flag is set to true and registration is then finished at step S21. If a response is not received, then it will sleep for one second and try again from step S15. This will continue indefinitely until the application cancels its interest or the remote clerver replies. The sleep value (in this case 1 second) can be set at different values depending on the application.

Once registration is successful, the loop will continue, but this time replacing registration requests with heartbeat signals in S19, (not shown in FIG. 4). The registration loop has effectively transformed itself into a heartbeat loop. If at any point the heartbeats fail due to the remote clerver going down or any network problem, this loop returns to the first mode of operation and will try to get registered again.

On the remote clerver's side, the registration structure exists only as long as a client is currently successfully registered and maintaining heartbeats. Registration failure or heartbeat failure result in the removal of this structure. The only thread involved on the server side is Atropos (decrementing TimeToLive counts) which applies to all client clervers. There is only one of these per clerver.

FIG. 5 illustrates the steps taken by the remote clerver during the registration process. Initially the HostName, ProcessID, HostID and encrypted string from the local clerver is read in step S23.

A Clerver ID object is then created in step S25 to store the HostName, ProcessID and HostID of the local clerver. The string is then decrypted in step S27 using the ProcessID, HostID and current time.

In S29 whether or not the string can be decrypted is determined. If the string can be decrypted, the authentication flag which is set at the remote clerver side is set to true in step S31. If the string cannot be decrypted, then it is set to false in step S33 and returns a FALSE to local clerver in step S43.

The HostID, ProcessID, HostName, ClerverName and the HTTP address (if supplied) of the local clerver is then stored in the Clerver ID object which was created in step S25.

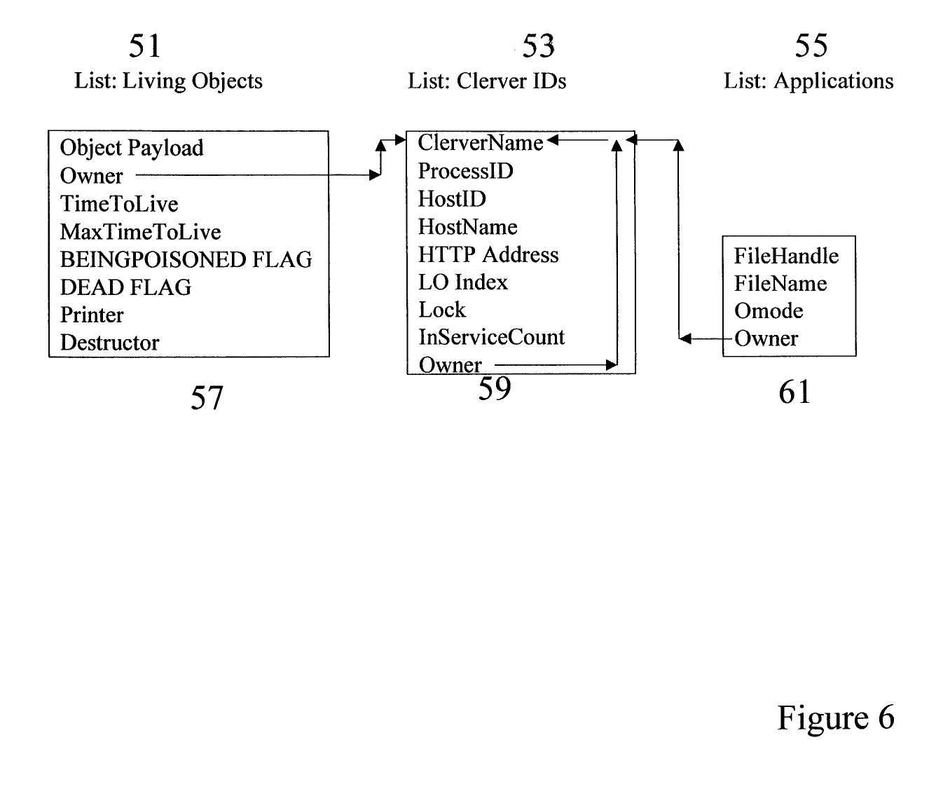

A new flag called “BEING_POISONED” is then set to false in step S37. The BEING_POISONED FLAG will be explained in more detail with reference to FIG. 6. However, its basic fimction is to prevent commands reaching a living object when it is about to die and to allow extant threads to terminate prior to completion should their task be a long one.

Once the Clerver ID object has stored the above information, a living object is created corresponding to the Clerver ID and it is added to a list of living objects which are set up in the remote clerver. This step will be explained in more detail with reference to FIG. 6.

The Clerver ID object (N. B. not the living object) is then added to a list of Clerver IDs in step S41 which are also set up on the remote clerver.

In step S43 either true or false is returned to the local clerver. Which one is dependant on the Authentification Flag set at either step S31 or S33. If registration is successful, the local clerver's responsive flag is set to TRUE. The local clerver also preserves a count of how many threads are using the Server ID in case a clerver application is routing data to more than one other clerver. Some of these may be running in the same physical machine. A clerver only ever has one registration to another no matter how many threads are sharing it. When the application requests the removal of a registration, the count held by the local clerver is decremented. Only when that count reaches zero is the responsive flag set to FALSE.

FIG. 6 shows in detail the Living Object list 51, Clerver ID Object list 53 and application list 55 set up in the remote clerver in order to manage Clerver ID objects and applications objects. The living object list 51 in this particular example comprises one living object 57. In this example, the living object wrapper structure has 8 attributes. The first is the owner which points to the living object's Clerver ID, which in this figure is shown as Clerver ID object 59 in Clerver ID object list 53.

The living object comprises an object payload which is the data payload of the object. In a living object corresponding to a Clerver ID, this will just be a pointer to the Clerver ID Object. However, if the living object relates to a service that is used to help realise an application, then the object comprises the data payload for this service. The wrapper then comprises a TimeToLive integer which will be slowly decremented until the living object is given a refresh signal from the local clerver. When a refresh signal is received, the TimeToLive integer is set to the value of the MaxTimeToLive integer which is also stored in the living object wrapper.

The living object wrapper also comprises two flags, the BEING_POISONED FLAG and the DEAD FLAG. The BEING_POISONED FLAG indicates when the TimeToLive for the object is zero and when the resources associated with that object can be released or are being released. When the TimeToLive is zero and the resources associated with the object have been released and the object is ready to be deleted, the DEAD FLAG is set to TRUE.

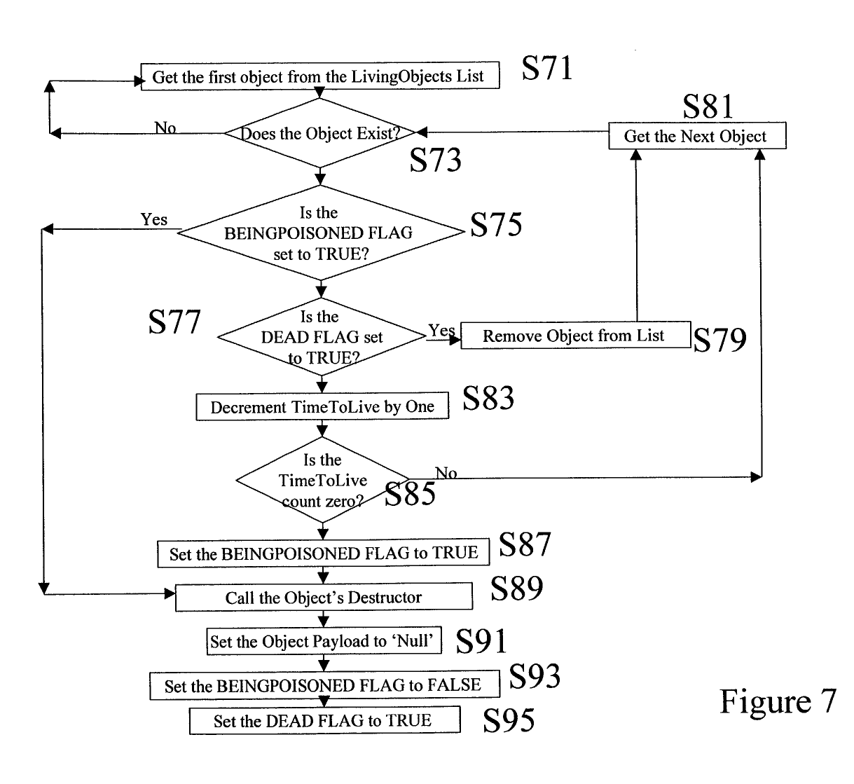

This happens in the following manner. When a ClerverID is required to die, BEING_POISONED is set TRUE. The Atropos thread then waits up to 10 seconds for all threads associated with it to terminate as a result of the state of this flag. DEAD is an indicator from the Atropos thread to the Lachesis thread that its job is done. Lachesis is a single thread running exactly once per clerver managing all living objects. Atropos is a transient thread created by Lachesis when a living object is to die. Lachesis runs always; Atropos exists only long enough to oversee the execution of one living object. This is so Lachesis does not block even if the task being terminated by Atropos does. These threads are outlined in FIG. 7.

There are also two functions, the destructor function and the printer function. Both of these apply to the object (i.e. the data payload). The destructor finction frees the data payload and its resources when the BEING_POISONED FLAG is set to TRUE. The printer function is used in order to log the status of the object.

List 53 is the Clerver ID Object list and has a Clerver ID Object 59.

As previously mentioned, the Clerver ID Object comprises the HostID, ProcessID, HostName, local ClerverName. It may also comprise the HTTP address of the local clerver which allows the web pages served by this remote clerver to reference all of the web pages of the clervers connected to it, i.e., in this example, local clerver. Thus, it is possible for a user to hop from clerver to clerver to look at different parts of the web.

The registration also comprises a LO Index (Living Object Index) which is assigned to the registration structure when the living object is created. It allows identification of the living object wrapper which contains the registration data. This can obviously be implemented in different ways. It is the ID that is important irrespective of implementation. For example, this could be done with linked lists in which the ID would be a pointer rather than an index.

In addition to the above, the registration structure comprises a Lock variable. It represents an atomic lock at the operating system level and guaranties that only one thread can access the object at once. The registration structure also comprises an InServiceCount which work together to delay the destruction of the registration until all running tasks have been completed. Tasks which take a long time can look at the BEING_POISONED flag during operation and elect to “give up” if it becomes set to indicate that the object is BEING_POISONED. Also, misbehaving tasks can be killed using these two features.

The remote clerver also has an applications list 55. A single request to open a file 61 is seen in the applications list. In this particular example, the owner of the application object points back to the Clerver ID Object. When the Clerver ID Object dies, the application will also die after it is terminated properly.

FIG. 7 is a flowchart showing the Lachesis thread which manages the TimeToLive variable of the living objects and also the Atropos thread which terminates the object and frees its resources. In step S71, the first object from the living object list (i.e. lists 51 of FIG. 6) is obtained. In step S73, the thread looks to see if the living object exists, i.e. are there any objects in that list.

If an object is found, step S75 examines the BEING_POISONED FLAG for that object. If it is set to TRUE, then the destructor for that object is called. If the BEING_POISONED FLAG is FALSE, then in step S77 the thread checks to see if the DEAD FLAG is TRUE. If the DEAD FLAG is TRUE, then the object is removed from the list in step S79 and the next object from the list is obtained in step S81 which loops back to step S73.

If the DEAD FLAG is FALSE, then the object is alive and the TimeToLive count is decremented by one in step S83.

Step S85 checks to see if the decremented TimeToLive count is zero. If it is not, then the next object is obtained in step S81 and the process loops back to step S73.

If the TimeToLive count is zero in step S85, the BEING_POISONED FLAG is set to TRUE in step S87. The BEING_POISONED FLAG set to TRUE means that the object cannot receive any more calls from the local clerver. This prevents the system from “exploding”.

BEING_POISONED allows threads to elect to terminate before task completion. Specifically, it represents the state between ‘living’ and ‘dead’. A registration object cannot move to the ‘dead’ state before all the living objects belonging to it have died naturally. Atropos can terminate any that do not die naturally, but BEING_POISONED remains until all are dead one way or another.

The Atropos part of the thread is then started in step S89 and the object's destructor (see FIG. 6) is called. If in step S75 the BEING_POISONED FLAG is set to TRUE, then the destructor is also called at step S89. The object's destructor releases the resources concerned with that object.

The object payload is then set to null in step S91. The BEING_POISONED FLAG is then set to FALSE in step S93 and the DEAD FLAG is set to TRUE in step S95. As the DEAD FLAG is now set to TRUE, the next time this object is encountered by the Lachesis thread, step S77 will serve to remove the object from the list of Living Objects.

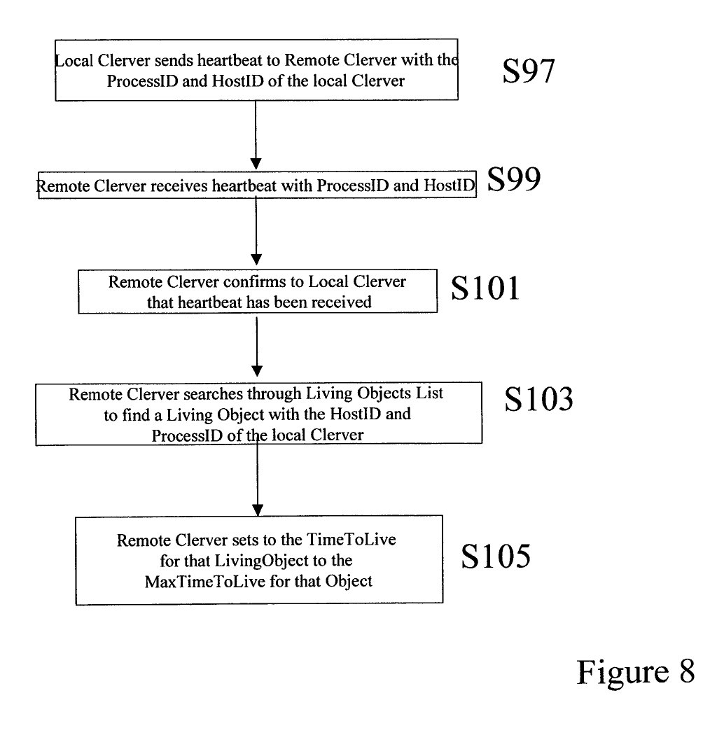

FIG. 8 shows an overview of the Clotho thread which resets the TimeToLive to the MaxTimeToLive in the living object.

Here, the local clerver sends a heartbeat to the remote clerver. The local clerver performs this function by having a Clotho thread associated with each server ID object in its Unique Server ID list. Thus, if the local clerver was connected to three remote clervers, then three remote Clotho threads will be running simultaneously. The Clotho thread causes the local clerver to send a heartbeat to the remote clerver with the ProcessID and HostID of the local clerver in step S97 at a predetermined interval.

The remote clerver receives this heartbeat in step S99 and confirms to the local clerver that the heartbeat has been received in step S101. If the local clerver does not receive this confirmation, then it presumes that the link between it and the remote clerver has gone down. The local clerver will, if necessary, save status information such that, if a link comes back up, the local clerver can re-start the job at the same place.

The local clerver will notify its application that contact with the remote clerver has been lost. The application may use this information to save status information if it so wishes.

If the remote clerver has received the heartbeat, it searches through its living object list in step S103 to find a living object with the ProcessID and HostID of the received heartbeat from the local clerver. Once the remote clerver finds such an object, it sets the TimeToLive variable of this object to the MaxTimeToLive value for this object in step S105. During this step S105, the remote clerver does this, not just for one object, but repeatedly for each object it finds that matches this description.

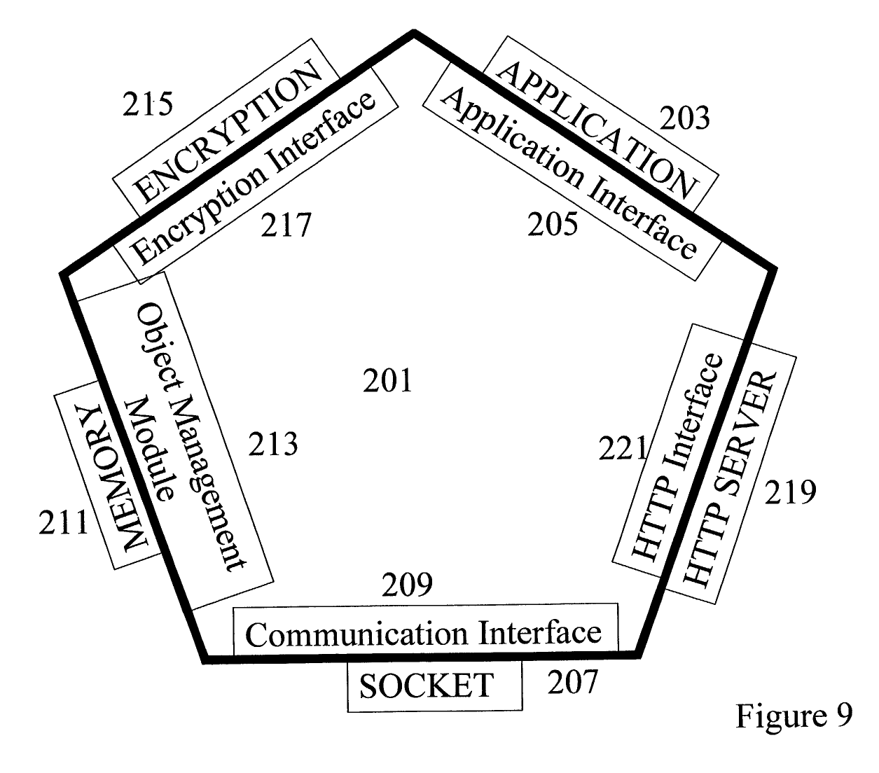

The previous figures have concentrated on how the remote clerver and local clerver communicate. FIG. 9 shows a schematic of a clerver structure.

The clerver itself is a multi-faceted code module. In the embodiment of the clerver illustrated in FIG. 9, the clerver comprises five main functions. First, the clerver 201 comprises an application interface 203 which is intended to interface with the application 205. Clervers are not strictly applications themselves. However, applications are built upon them. It is possible for one machine to host a number of applications each having their own clerver. Although the HostID and also the HostName would be the same for a number of clervers running on the same machine, the ProcessID and also the ClerverName would be different for each clerver.

As previously mentioned, if the clerver is acting as either a client or a server, it stores data in the form of objects, living objects and organises these objects into lists. It stores such data in the memory 211 of its Host. In order to manage this data in the memory, the clerver 201 comprises an object management module 213.

As previously mentioned, the clerver 201 is provided between the application layer 203 and the SOCKET layer 207. Thus, the clerver also comprises a communications interface 209 which corresponds directly with the socket layer 207 in order to send and receive data from the internet, a LAN, a WAN or wireless network.

For example, when a registration request is sent from the local clerver to a remote clerver, the data passes from the clerver 201 through the communications interface 209 into the socket layer 207 and via the internet, LAN, WAN, or wireless network to a remote clerver. Similarly, when the application 203 has requested data from a remote clerver, the received data passes through the socket layer 207 into the clerver via the communications interface 209 and into the application 203 via the application interface 205.

As already referred to, the clerver also comprises an object management module 213 which interfaces to the clerver 201 with the memory of the host in order to manage the object lists, registration lists, server ID lists etc. stored in the memory 211.

Although the clerver could send and receive encrypted data, its security is obviously enhanced by the ability to encrypt and decrypt data 215. In order to communicate with encryption software, the clerver is provided with an encryption interface 217. The encryption interface can interface to commonly available encryption software or clerver-specific encryption software. Previously, encryption has been discussed in relation to S17 of FIG. 4 where the HostID, ProcessID and current time are used to encrypt ClerverName. This encryption would be provided by encryption software 215 managed by encryption interface 217.

Preferably, the clerver 201 also comprises a HTTP interface 221 which allows the clerver to publish web pages using HTTP server 219. The HTTP server 219 can output web pages which show the status of this clerver 201 or which can potentially show the status of any clervers to which this clerver 201 is linked.

A primary significance of the HTTP interface is that it permits a new level of internet connectivity to be introduced without sacrificing compatibility with the existing Web. It makes the clerver mechanism backwards compatible. It enables the existing servercentric world of the Web to coexist with an emerging peer-to-peer end-to-end-security computing paradigm.

Security is inbuilt into the web interface and there is a defined gateway for what the application code can provide to a web page (information and tasks to be done) allowing the graphical user interface (GUI) to be designed in isolation. A GUI designer can request a ‘document yourself’ page which details the interface provided to the application. This allows application designers to write functions that reflect the operation of the application without thought of how the GUI will use them and the GUI designer to use that information to add functionality to the GUI without needing application code changes.

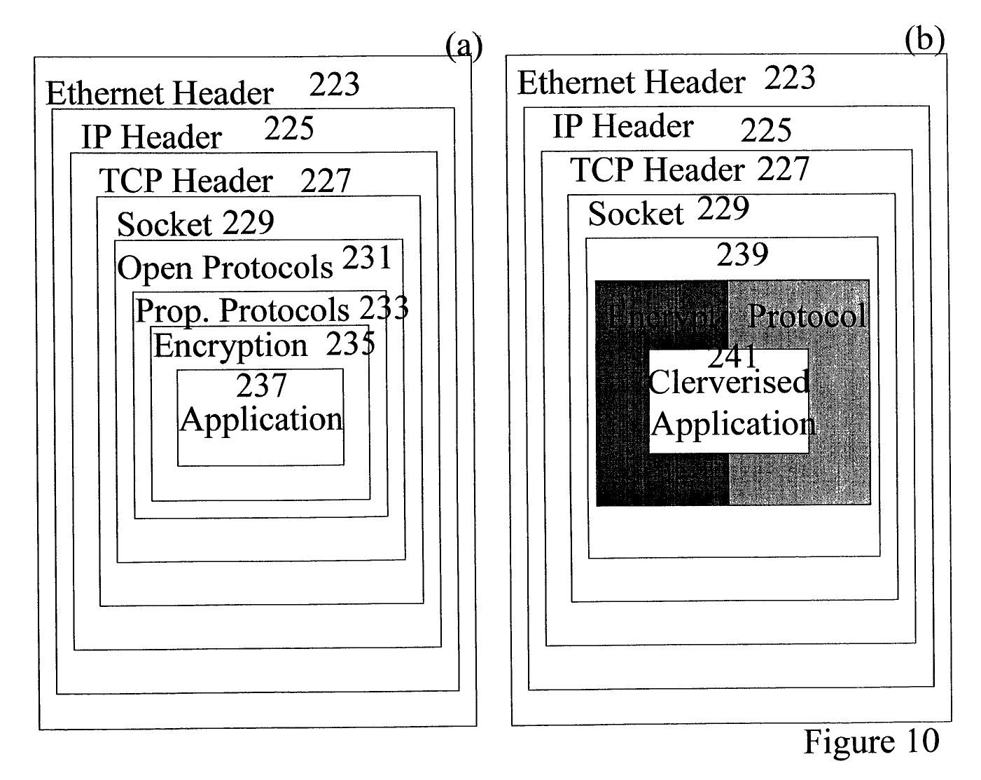

Although the above clerver mechanism provides a far more flexible system than other file transfer and communication approaches, the clerver also remarkably provides a more simplified layer structure. FIG. 10 illustrates a schematic of a stack for a conventional server (FIG. 10a) and the stack for a clerver (FIG. 10b).

First, considering the layer structure of FIG. 10. The data layer is the most basic layer and serves to route data across a LAN; the data layer provides an ethernet header 223 and ethernet trailer at the start and end of the ethernet data portion. The TCP/IP suite is then provided, and comprises a network link layer and a transport layer. The network link layer places the data in packets into the ethernet data portion. Similar to the data link layer, the network link layer arranges its data with an IP Header 225 followed by an IP data portion and then an IP trailer. The transport layer places the communication streams it manages in the data portions of IP packets. Again, this is arranged in the form of a TCP header 227, a TCP data portion and a TCP trailer. The TCP/IP suite serves to move the data across LANs and network links as requested. However, it does not perform either functions such as ensuring that data arrives in order and without duplication. In order to do this, other protocols such as open protocols 231 and proprietary protocols 233 are required. These protocols sit on the opposing side of the socket layer 229 to the TCP/IP suite.

As it is relatively easy to intercept files sent over the internet, encryption can be used. When encryption is used, a file produced by application 237 will be encrypted via encryption software 235, before it is passed to the proprietary protocols 233.

This complex layer structure is bypassed by using a clerver. A clerver layer structure is shown in FIG. 10b. As with a conventional client or server, the data link layer (ethernet) TCP/IP suite 223, 227 and socket layer 229 are required. However, here the clerver 239 interfaces directly with clerverised application 241 and socket layer 229. The clerver itself has its own encryption (see FIG. 9) and also uses its own protocol. Clervers must be capable of functioning as both clients and servers. Although many different protocols could be used, a preferred protocol is a modified form of RPC.

The above description relates to a specific configuration and a particular method of implementation. The principles can of course be implemented in many different fashions. For example, the above described implementation has been based on lists and indices. Equally, implementation could be based on the registration objects acting as a form of gateways to or managers of clervers.

FIGS. 2 to 10 have concentrated on the internal structure of clervers and how they perform basic functions. The formation of a living object allows the clervers to form pseudo-synchronous sessions with one another as each clerver has a code module which can detect the integrity of a link between it and another clerver. Further, if this link is lost, the clerver which is acting as a server is capable of freeing resources, and can notify the “client” about the status of a job so that the client can preserve status information to re-start the file from the same point once the link is re-established.

Further, clervers provide their own security benefits; they communicate using their own protocol and they have their own in-built encryption. Also, as the client clerver must keep sending a signal to its living object in the remote clerver with its HostID and ProcessID, intercepting a ‘virtual’ session is difficult.

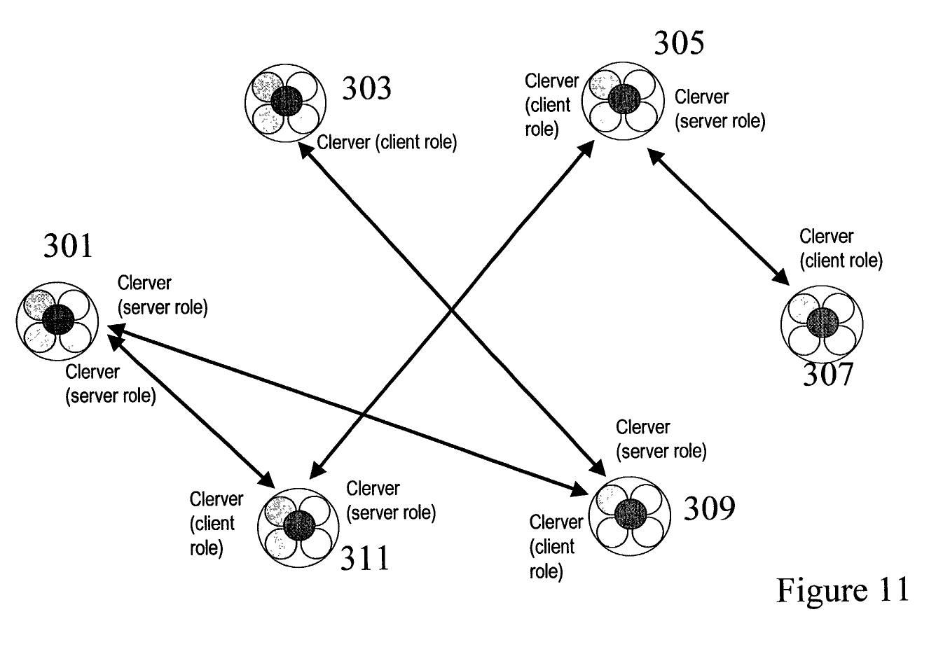

Thus, clervers provide an ideal platform for peer-to-peer computing as schematically illustrated in FIG. 11.

Here, six clervers are shown 301, 303, 305, 307, 309, 311. Each of the clervers can act as either a client or a server or both. Clervers 303 and 307 both act as just clients. Clerver 307 is a client to clerver 305 which is acting in a server role to clerver 307. Clerver 305 is itself a client of clerver 311 which although acts as a server to clerver 305 also acts as a client to clerver 301. Clerver 301 acts as both a server to client 311 and client 309.

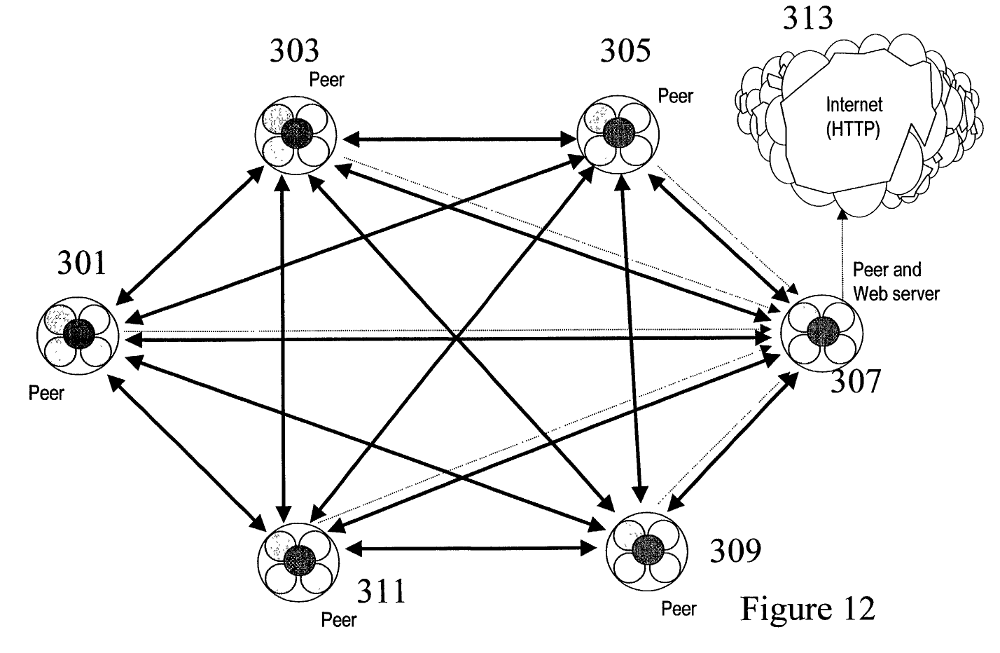

As mentioned with reference to FIG. 9, each clerver also has a HTTP interface. Therefore, it can publish pages to the web. FIG. 12 shows such an arrangement where each of the clervers of FIG. 11 are shown to publish pages direct to the web 313. Like reference numerals have been used to denote like features.

The clervers of FIG. 12 can act either as clients or servers. The solid lines in the figure indicate that each clerver can be connected to each of the other five clervers either simultaneously or one or more at a time. Each of clervers 301, 303, 305, 309 and 311 also form a virtual session with clerver 307. Clerver 307 publishes directly to the web 313 and has a hyperlink to each of clervers 301, 303, 305, 309 and 311, such that an individual accessing the web pages of web server 307 can view the web pages of clervers 301, 303, 305, 309 and 311.

The above arrangement provides a perfect platform for running distributed applications. Such applications can run in a collaborative or a co-operative mode. In a collaborative mode, each clerver will share a single logical entity and each clerver will run its application consecutively. This is similar to how IBM's Lotus Notes operates. In general, replication is used to enable multiple users to collaborate in a sequential manner on a single piece of data. Only one person can manipulate the data at one time and ownership is sequential.

In a co-operative mode, separate sub-applications run on several separate machines which co-operate together to achieve a desired result. No one machine is able to do all the work so it co-operates with other machines.

For example, such a distributed environment could be used to solve the problems associated with managing distributed generic workflow amongst internet users. Although it is known how to manage workflow using proprietary main-frame systems, providing an accepted solution outside the boundaries of the corporate network is virtually impossible. A company having its own LAN will retain the files on a single server and each file is called by a device for editing or updating. However, the file remains on the server all the time. The reason for this is that other devices on the LAN cannot tell the details of the status of the file if it is located on another device.

Further problems arise if there is a need to manage workflow between two organisations, each having its own separate LAN. It is possible to link the two servers of the individual LANs together. However, this is not an ideal solution because the internet introduces a degree of unmanaged and unmanageable variability in connectivity that proves disruptive to consistent application performance.

The internet connects millions of devices together using identical technology standards and techniques. Within a LAN environment, internet techniques are described as an intranet. When two or more LANS are connected using internet techniques, they are described as an extranet. Extranets can work satisfactorily under stable, usually private, membership requirements, but tend to be time-consuming to set up and difficult to manage and certainly do not provide suitable facilities for flexible, ever-changing membership requirements. However, using clervers as opposed to clients and servers between LANS or any other devices connected to the internet, it is possible to move files from any clerverised device on the internet to any other clerverised device on the internet irrespective of LAN membership. The delivery of files is guaranteed, and the senders of files will be able to confirm that receipt was successful. Both senders and receivers can re-send or “trouble-shoot” files that for any reason have been damaged.

Further, it allows anybody who is so authorised to see who has the file and status of the file. Also, it is desirable for an authorised user to be able to obtain an audit trail of the file.

The above clervers provide these advantages as previously explained. In a typical workflow environment, any clerver can work on the file and safely transfer the file to another clerver. When the clerver changes the status of the file or its location, it communicates meta information to the web server. The web server may be run on a clerver which may also wish to use the file or it may be a completely separate device which can, for example, run a web server. Therefore, by checking the relevant web page, any of the devices in the network can automatically check to see the status of the job.

Also, an audit trail which shows the movement of the file can also be displayed. It is also possible for the web page to have hyperlinks to the actual data file on the clervers.

At this point, it is important to distinguish between data and metadata. Metadata is data which indicates the location, status, etc. of a datafile, job etc. For example, in the above example in FIG. 12, the file can be transferred between clervers 301, 303, 305, 309 and 311 as required. Each of these clervers sends metadata to the web server 307. This metadata is then published to the web 313 so that the location and status of the file can be determined from the web.

This arrangement could be applied to the field of creating art work. In the arts and media fields, there are many free-lancers which may collaborate together on certain projects. By using clervers, the client can send a job to an agency which then farms the job out to studios/illustrators. The client can monitor the progress of the work and so can the agency by checking the designated web page. Further, safe file transfer is assured because of the use of the clerver as well.

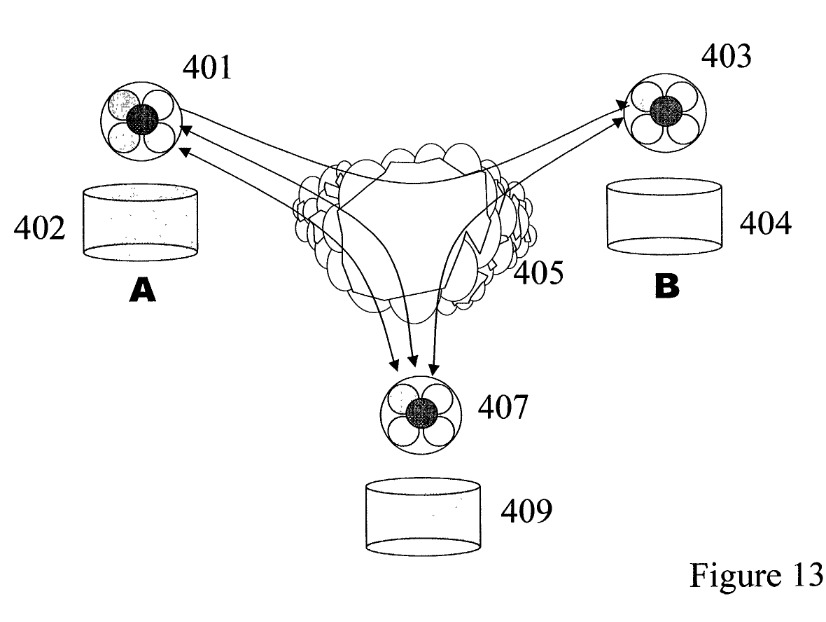

FIG. 13 shows a clerverised email application. Here, clerver A 401, wishes to send a message to clerver B 403 through the internet 405. In the conventional email system (not shown), the sender of the mail (in this case clerver 401) would send the email to the service provider. This email would then be stored on the server of his service provider. The email would then be forwarded by the sender's email service provider to the recipient's email service provider where it would again sit on a server. Eventually the recipient would download email from its own service. This has drawbacks because the email passes through two servers before it is received by the recipient. This can cause unpredictable delays and also makes the system insecure as the sender's and recipient's email servers could both be hacked to obtain the message. Also, as there is no direct communication between the sender and recipient, encryption can only be used if both the recipient and sender have agreed in advance. This again makes the system rather insecure.

Clervers provide a unique way of securely sending email. Before the start of the transmission, clerver A 401 and clerver B 403 will register with clerver 407 which provides a registry. The registering procedure for both clervers is the same as that described with reference to FIGS. 3 to 6. Once clerver A has registered, it then contacts registry clerver 407 in order to obtain the address of clerver B 403. The registry clerver 407 will also inform clerver A 401 if clerver B 403 is on-line. If clerver B 403 is not on-line, then the email sent by clerver A 401 can be handled under two options:

1) Store the email on system A 402 outbox for future transfer.

2) Store the email on the registry server 409.

If clerver B 403 is on-line, then clerver A 401 registers with clerver B 403 in the same manner as described with reference to FIGS. 3 to 6. Clerver A 401 then sends the email to clerver B 403. Clerver B 403 is able to acknowledge receipt and confirm that the email has been received securely. Also, as clerver A 401 and clerver B 403 have a virtual session formed between them, clerver A 401 is also able to request data transmission from clerver B 403 to clerver A 401. Thus, clerver A 401 could look at the inbox (or, more preferably, a subset of the inbox to which clerver A 401 has been allowed access) in order to check if clerver B 403 has correctly received the email.

This ability to request a page impression of the inbox from clerver B 403 also allows clerver A 401 to determine without doubt when the user of the clerver B 403 has read the email.

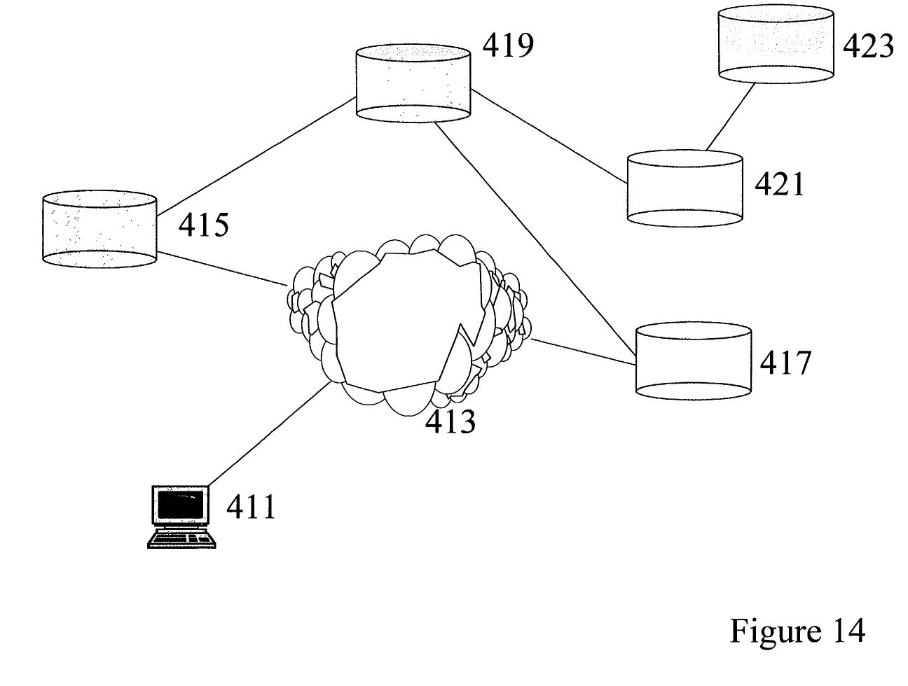

Clerverised applications can also help ecommerce transactions. FIG. 14 shows a prior art system for performing a credit card transaction through the internet 413. In such an arrangement, the buyer 411 once he has decided on his required service sends his credit or debit card number to a merchant web site 415 or an ebusiness service's or payment service provider's web site 417. The card number is stored by merchant server 415 or by ebusiness service 417. The card number is then sent to the acquiring bank 419 over a private network. The acquiring bank 419 then communicates with the credit/debit card issuer 421 in order to progress the payment transaction. The credit/debit card issuer then communicates with the issuing bank 423. In this type of transaction, the credit/debit card numbers need to be stored on the merchant's server 415 or ebusiness/payment service provider's server 417.

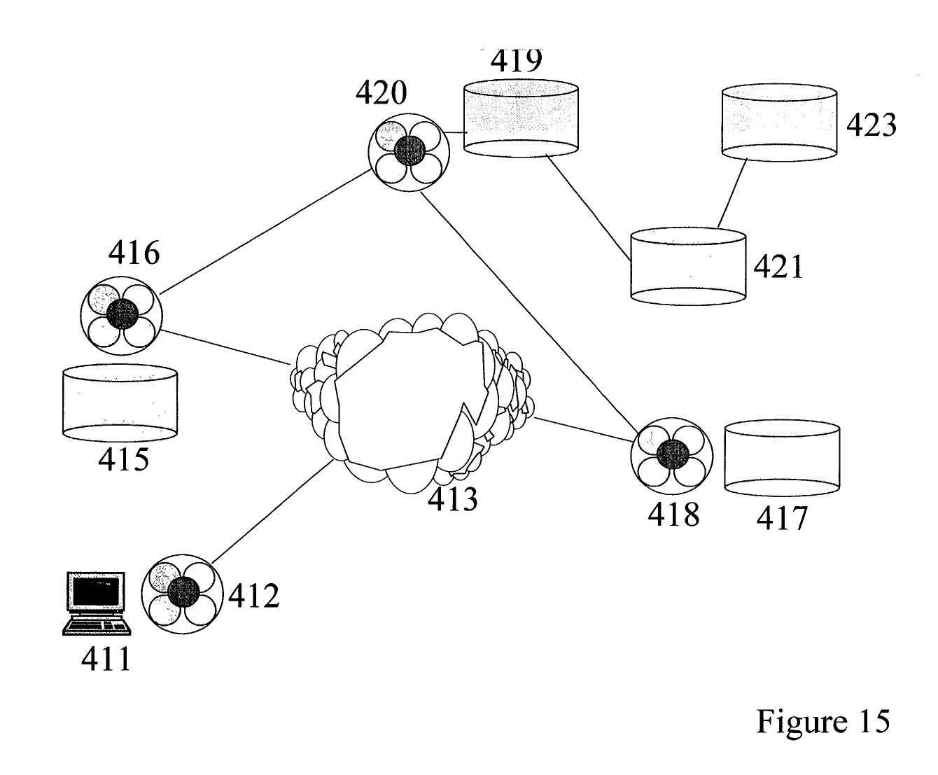

However, this whole system can be clerverised as shown in FIG. 15. Here, the buyer 411 has a clerver 412. The clerver 412 registers with either clerver 416 at the merchant or clerver 418 at the ebusiness service/payment service provider. The acquiring bank 419 also has a clerver 420. The merchant clerver 416 and ebusiness service's clerver 418 are in constant communication with the acquiring bank's clerver 420. When a buyer wishes to effect an on-line purchase, he registers with either the merchant clerver 416 or the ebusiness/payment service's clerver 418 (or both). When the user 411 decides to pay for a purchase, the credit card number is sent to either the clerver of the merchant 416 or ebusiness/payment service provider 418. Both of these clervers, 416, 418 are registered with the acquiring bank's clerver 420. This acquiring bank 419 then communicates with the credit/debit card issuer 421 in order to progress payment. The credit/debit card issuer 421 then communicates with the issuing bank 423. As there is direct communication between the buyer's clerver 412 in his machine 411 and the clervers 416 and 418 of the merchant and the ebusiness/payment service provider respectively, there is no need for credit/debit card numbers to sit on the merchant server 415 or ebusiness/payment service provider server 417. If the credit/debit card company 421 and the issuing bank 423 both have clervers, there are further opportunities to optimise the process flow and reduce the number of points at which credit/debit card numbers are stored.

Previously, it has been mentioned that clervers provide their own encryption. In addition, the encryption clervers can also negotiate to switch sockets to provide an extra level of security.

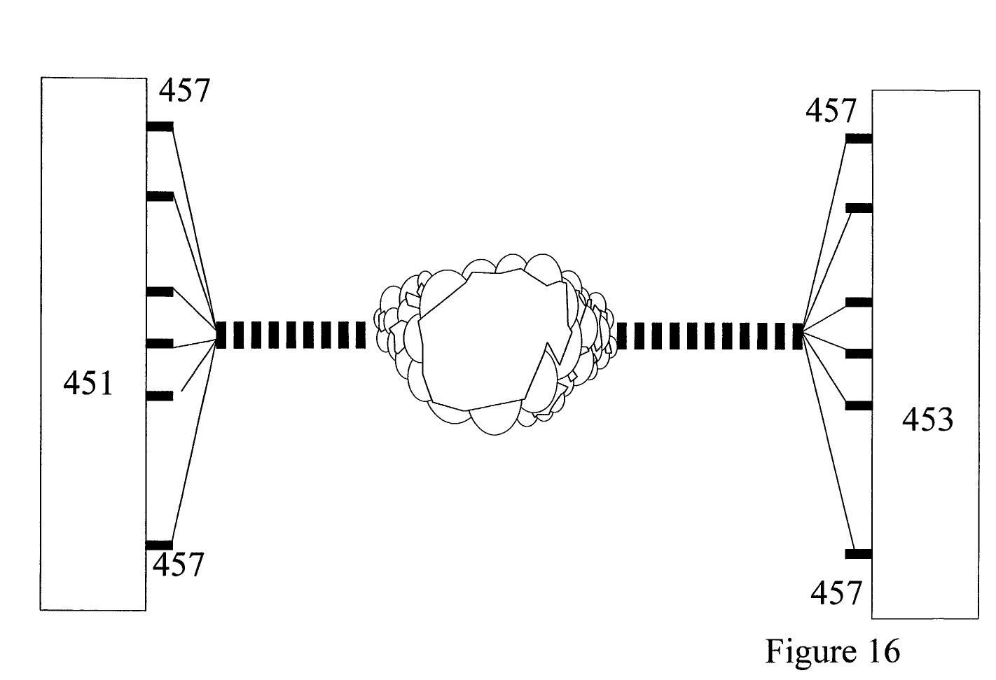

In FIG. 16, clerver A 451 wishes to send an encrypted message to clerver B 453. Clerver A 451 can communicate with clerver B 453 on a plurality of different sockets 457. Thus, in addition to using encryption, clerver A 451 and clerver B 453 can negotiate to switch between sockets 457. This means that an eavesdropper will have to listen on all of the sockets in order to obtain the data instead of being able to select only packets encrypted with standard encryption (such as SSL) using a publicly known socket. For a 32-bit machine, there are 64,000 sockets. This increases to billions in 64-bit machines, making it virtually impossible for an eavesdropper to listen to all sockets.

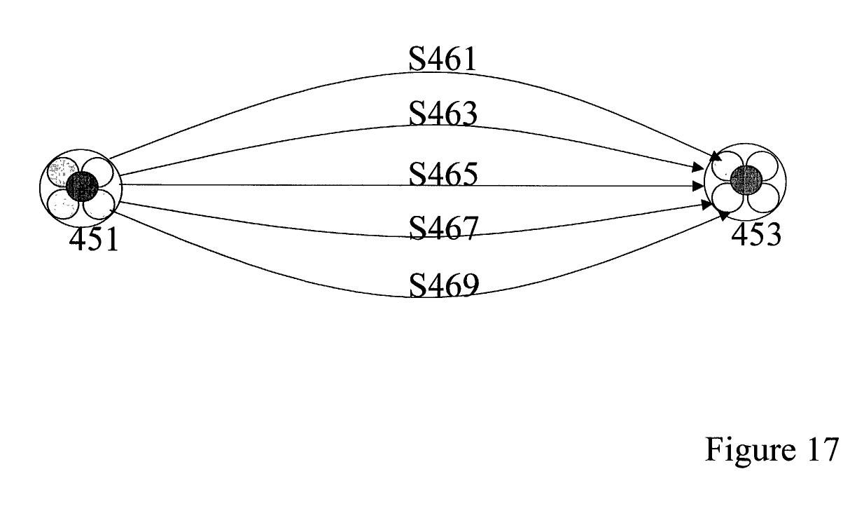

FIG. 17 shows an example of a file transfer between clerver A 451 and clerver B 453 using the socket switching of FIG. 16. In step S461 clerver A 451 first registers with clerver B 453 in the manner described with reference to FIGS. 3 to 6.

Clerver A 451 divides the data which is to be sent to clerver B 453 into a predefined number of portions. Where the sub-divisions between the data takes place and the size of each sub-division can be determined by clerver A 451. However, obviously, clerver B 453 must know how to read the data. Each portion is then encrypted and each data portion is bundled with data indicating its size, its position in the reassembled data, its actual position in the transfer sequence and a variable either indicating the port ID of the next portion to be transferred or indicating that this is the last portion.

In S463, (this happens after registration), the first portion of the sequence is transferred. The connection is then closed and a new connection with a new port ID is opened in S465. Then, the next data portion is transferred in step S467. The port connection is then closed and a new port is opened in step S469. The above steps are then repeated until the data transfer is completed. Alternatively, multiple ports could be opened simultaneously to achieve parallel transmission of the data portions and hence factor transmission across the internet.

Previously, the concept of metadata which contains information about the location, type, attributes etc. of real data which is stored at a central point has been discussed. Specifically, this was discussed with relation to the workflow example of FIG. 12.

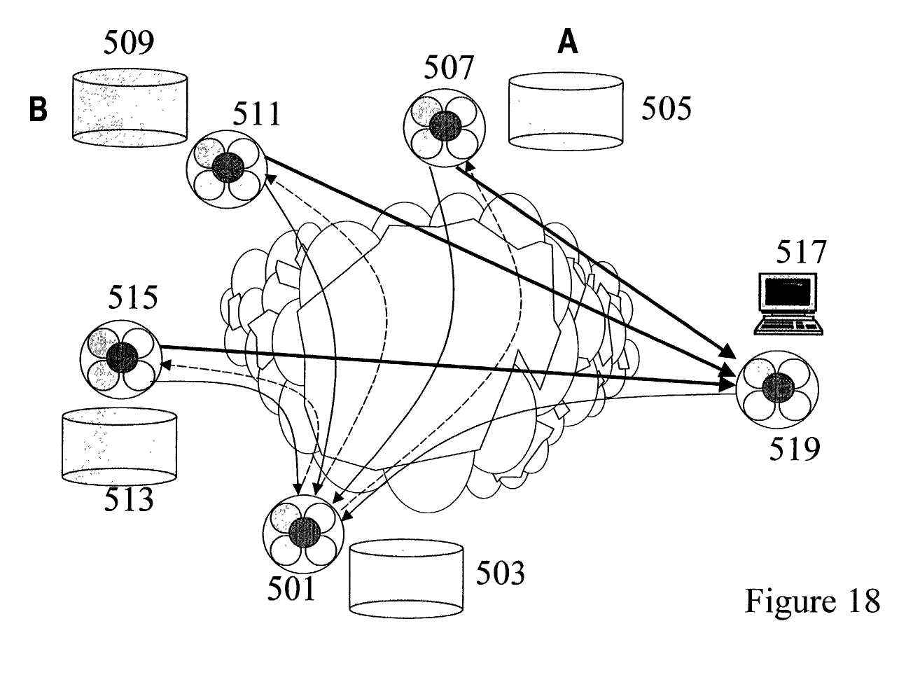

In FIG. 18, an internet advertising system based on clervers is shown. One clerver 501 is connected to registry 503 which stores metadata. In this particular case, the metadata is related to advertisements. In this particular example, merchant A 505 sends his metadata relating to his advertisement, (for example, the location, type of advertisement etc.) via his clerver 507 to registry clerver 501. Merchant B 509 also sends his data via his clerver 511 to the registry clerver 501.

Some merchants subcontract their advertisements to a service company 513 which also has a clerver 515 to register the metadata of the advertisements held by the advertisement service company with registry clerver 501. The step of the merchants' clervers 507 and 511 and the advertisement service's clerver 515 sending their metadata to the registry clerver 501 is shown by thin solid lines.

If a potential buyer 517 wishes to look at advertisements of a particular type, for example bicycles, then he sends a message via his clerver 519 to the registry clerver 501 requesting such information (thin solid lines). The registry clerver 501, using its metadata, instructs (dotted lines) advertisements and offers to be sent from each of the merchants' and advertisement service's clervers, 507, 511 and 515 to the user's clerver 519 (heavy solid lines). This has the advantage that the buyer receives the most up-to-date information from the merchants and advertising service because he is directly communicating with the merchants' and the advertisement service's clervers as opposed to just contacting an advertisements' registry located elsewhere by a provider on the web where real time updating of the advertisements is not possible.

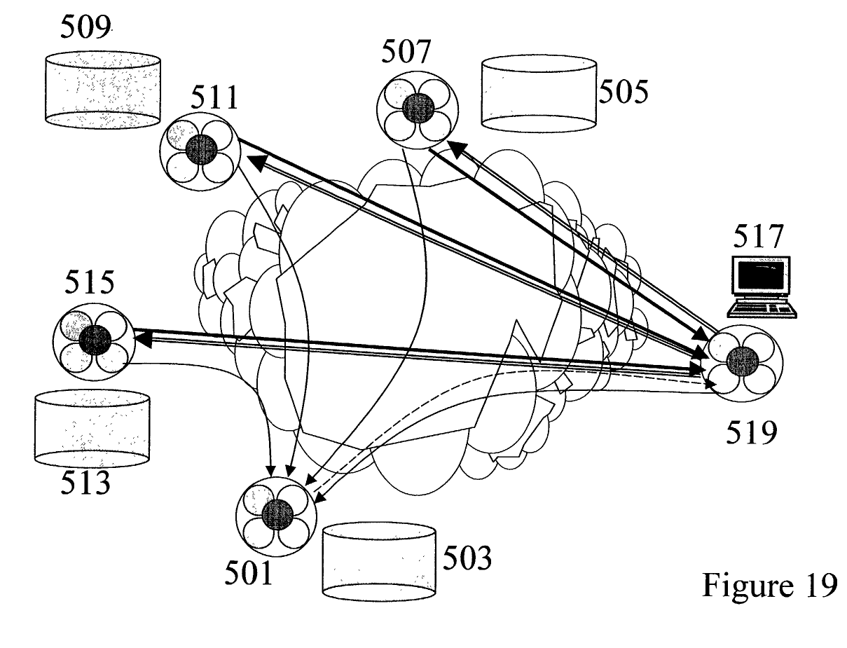

FIG. 19 shows a variation on the advertising service of FIG. 18. To avoid unnecessary repetition, like reference numerals will be used to denote like features. In this example, the clervers 507 and 511 of the merchants 505 and 509 and the clerver 515 of the advertisement service 513 again send metadata including the location and the type of the advertisement to the registry clerver 501. When the buyer requests advertisements from the registry clerver 501 (thin solid lines), the registry clerver 501 sends to the buyer the metadata indicating the location and attributes of the advertisements from the merchants or advertisement service (dotted line). The buyer's clerver 519 then contacts the merchants' clervers 507 and 511 and the advertisement service's clerver 515 directly (twin solid lines) and these clervers then send the advertisements direct to the potential buyer (heavy solid lines). This variation on FIG. 18 again provides the same advantages that, as the buyer is in direct contact with each of the merchants and advertisement service, then it knows that it obtains the most up-to-date information. Electronic leafleting and promotional offers and tactical marketing initiatives are good examples for this type of advertising.

The metadata above can include any number of pieces of data. In a particularly preferred example, the telephone code associated with the merchant is also stored on the registry server 501. Thus, if the potential buyer is only interested in purchasing a product within a certain area, then he can request only advertisements from merchants working in that area.

Previously, the security attributes of clervers have been discussed. However, as previously described with reference to FIGS. 3 to 6, when a clerver registers with another clerver, the HostID which is unique to the machine from which it is sent must be sent to the receiving clerver. Thus, if one clerver is found to be involved in a fraudulent process, then potentially such a machine could be tracked.

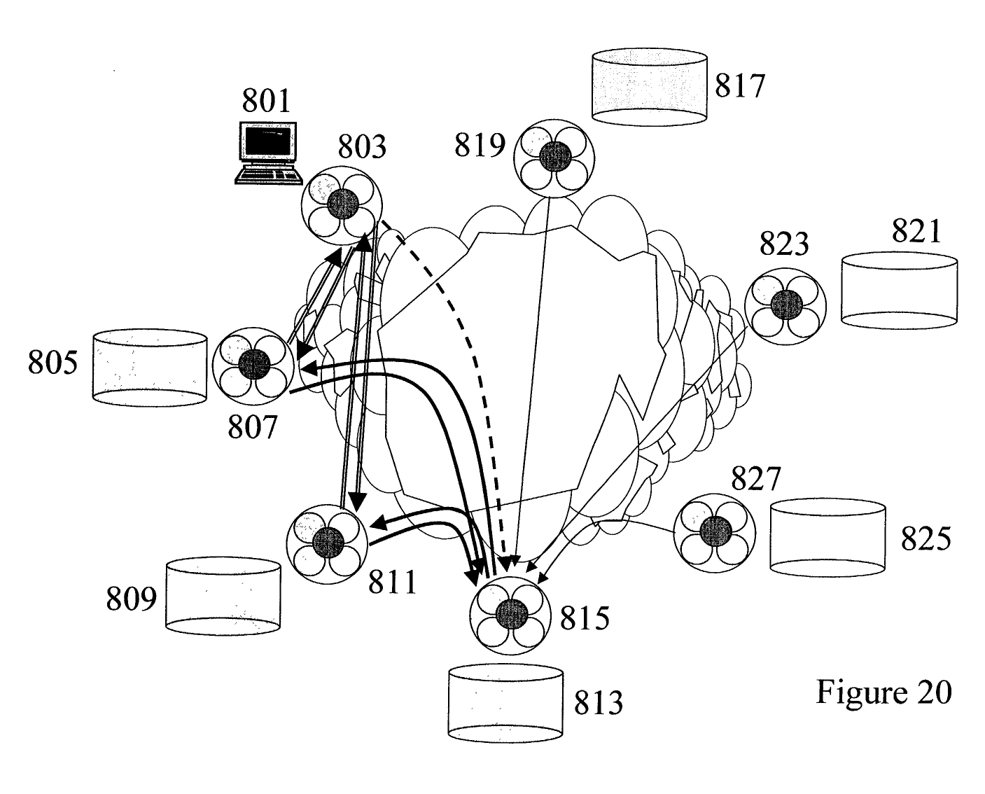

In the example of FIG. 20, banks 817 and 825 and credit/debit card company 821 use their clervers 819, 827, and 823 respectively to contact the clerver 815 of a registry 813. The registry 813 stores suspect HostIDs.

When a buyer 801 contacts, via its clerver 803, a merchant 805 via the merchant's clerver 807 or a payment service provider, 809, (if one is acting on behalf of a merchant,) via the payment service provider's clerver 811, the user supplies his credit/debit card number and his clerver 803 supplies the HostID of the user's machine 801 which is required as part of the registering process.

The merchant's clerver 807 or the payment service provider's clerver 811 as appropriate then contacts the registry clerver 815 to see if this HostID has been used in conjunction with previous stolen credit/debit card numbers. If it has, the merchant 805 or payment service provider 809 can refuse to accept credit/debit card transactions from such a suspect HostID or can carry out further checks. If the latter is the course of action chosen, the merchant's clerver 807 or the payment service provider's clerver 811 as appropriate can immediately contact the clerver 827 of the acquiring bank 825 and/or the clerver 823 of the credit/debit card company 821 as appropriate to inform them that a machine which has previously used stolen credit/debit cards has tried to use a further credit/debit card and to check if such a credit/debit card has been stolen. If the banks report that the credit/debit card has not been reported lost or stolen, the merchant 805 or payment service provider 809 can elect to proceed with the transaction but knows there is a higher degree of risk given the history of the device tendering the credit/debit card number than if a HostID was being used that had no history of tendering stolen credit/debit cards.

If the query by the merchant's clerver 807 or the payment service provider clerver 811 of the registry clerver 815 reveals that the HostID of clerver 803 was not on the list held by the registry 813, clerver 807 or 811 as appropriate assume there is no history of fraudulent use on that machine and pass the HostID through to the clerver 827 of the acquiring bank, 825. The acquiring bank 825 correlates HostIDs with credit card numbers on transactions it has been involved in. Alternatively and preferably, when it passes the credit/debit card details to the credit/debit card company 821, it also passes the HostID; correlations between HostIDs and credit/debit card numbers can then be undertaken by the credit/debit card company 821. When the credit/debit card company 821 passes the credit/debit card through to the issuing bank 817 for authorisation, it can also pass through the HostID. The issuing bank 817 then has an opportunity to see if the HostID submitted as part of the transaction matches a HostID supplied by the purchaser's clerver at the time the credit/debit card was issued and, in a new envisaged process (see below), authorised for online use. If the credit/debit card number accepted for the transaction subsequently turns out to have been stolen or used fraudulently, the acquiring bank 825, the credit/debit card company 821, or the issuing bank 817 as appropriate is able to identify from its records the HostID that was involved in that transaction and notify the registry 813 accordingly for future use by all other merchants, payment service providers and banks when handling online transactions. This action closes the circle.

Thus, it is possible to blacklist a computer from making such transactions, thus making the computer virtually worthless for this type of activity.

It might be argued that fraudulent users could spoof the HostID of their computers. However, this would be virtually impossible to achieve since the HostID forms part of the encryption process and also since the host machine 801 via its clerver 803 must stay in virtually constant contact with the merchant's clerver 807 or the payment service provider's clerver 811. A number of virtual private networks are effectively in place between the various parties involved in the transaction.

As a further example of the present invention, the capability of matching credit/debit card numbers with HostIDs of selected devices allows credit/debit card customers to elect to nominate particular devices as the only devices against which they wish their credit/debit card number to be accepted in an online transaction. Card-issuing banks also have the option of restricting use of credit cards to nominated devices.

Such an example will be described with reference to FIG. 20. Here, user 801 will register the HostID of his machine with his bank 817 or his credit/debit card company 821. This will be achieved via an interaction between the user's clerver 803 and the issuing bank's clerver 819 or the credit/debit card company's clerver 823 as part of the registration process for being able to use the credit/debit card for online transactions. Credit/debit card customers will be able to lift their restriction for selected periods of time such as, for example, when they travel abroad. If any of their nominated devices, which may include a mobile, a PDA, or any other internet-enabled device, are lost or stolen, they will register the loss or theft in the same way as they today register the loss or theft of their credit/debit card itself.

In FIG. 20, once a request for payment using a credit/debit card number is presented for payment by a merchant 805 or a payment service provider 809 to the acquiring bank 825, interactions between the acquiring bank 825, the credit/debit card company 821 and the issuing bank 817 are usually carried out at present on private networks and not on the internet. But if all parties to a transaction are using clervers, they are able to identify each other's HostIDs of individual machines and use them as a further tier of authentication. This capability potentially opens up the possibility of banks being able to complete the transactions between themselves on the internet itself and to optimise the process flow and the amount of infrastructure involved in supporting payment transactions. Completion of almost all online payment transactions both in business-to-consumer and business-to-business sectors involves multiple parties carrying out tasks both in parallel and consecutively. Such distributed types of application will benefit from the peer-to-peer and end-to-end security capabilities inherent in the design of clervers.

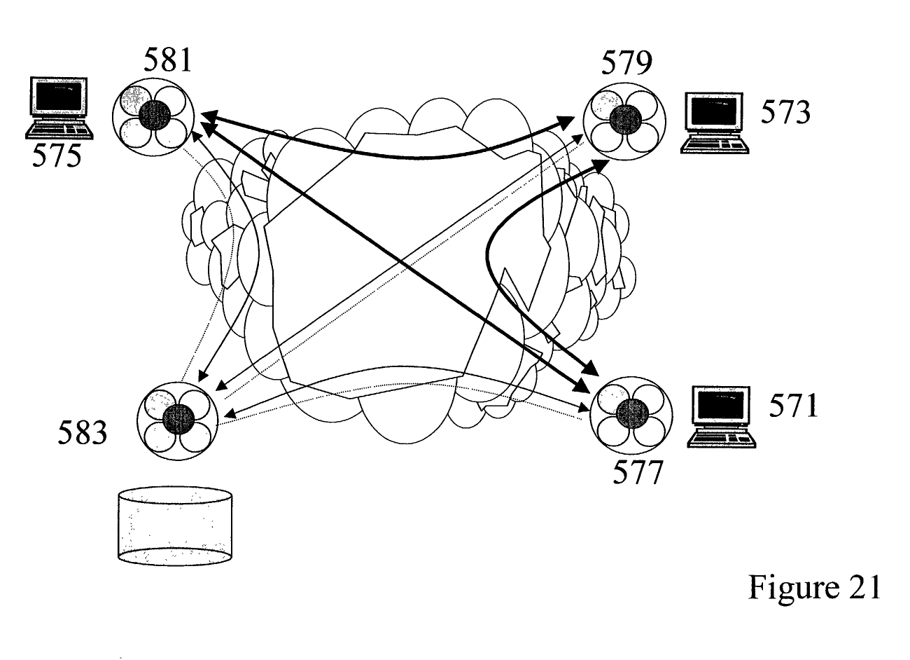

FIG. 21 shows a further embodiment of the present invention used for the player of multi-user games. Each of the users, 571, 573 and 575 each have their own clervers 577, 579 and 581 respectively. Actually, in this specific arrangement, each game will be a clerverised application. When a user is on-line, it registers with the clervers' game registry clerver 583. Once a user sees who is on-line, it then plays directly with those users. From time to time, each of the users' clervers 577, 579 and 581 send to the registry 58 metadata indicating the status, progress and scores such that further players can, if permission is granted, monitor the progress of the game and join in if the applications allow.

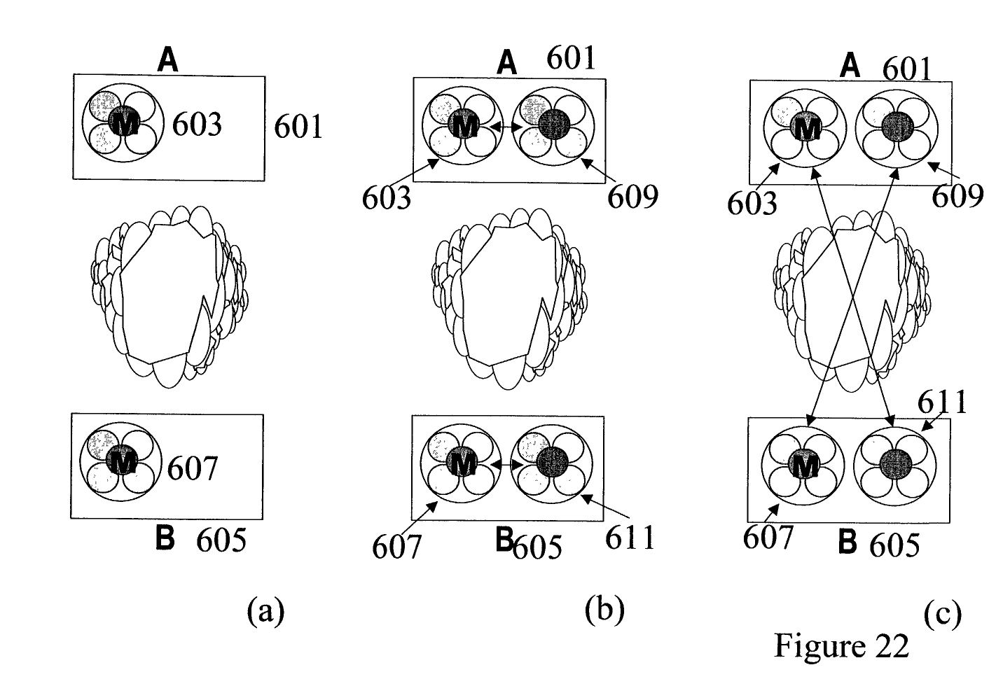

Previously, it has been discussed that a single device can run many clervers and that each of these clervers can choose the socket which they use. Also clervers can switch sockets during communication, (for example see the arrangement of FIG. 16). Thus, there needs to be some way of organising the clervers in a machine and also organising which sockets or at least registering which sockets they use. This is preferably done by the master clerver arrangement which is schematically shown in FIGS. 22a to c.

In FIG. 22a, device A 601 has a master clerver 603 which listens on a predetermined socket and always listens on this known socket. This socket is known to second device B 605 which also has a master clerver 607. In the same manner as master clerver 603 of device A, master clerver 607 of device B also listens on a well-known socket. The socket may be a different socket or the same socket that is used by master clerver 603. Device A 601 knows the socket which master clerver 607 of device B 605 uses and similarly device B 605 knows the socket which master clerver 603 of device A 601 uses.

In FIG. 22b, device A 601 has a master clerver 603 and a secondary clerver 609. Similarly, device B 605 has a master clerver 607 and a secondary clerver 611. First, considering device A 601, when secondary clerver 609 starts up, it communicates with the master clerver 603 to inform the master clerver 603 what services clerver 609 can offer and also which socket this clerver 609 uses. Similarly, the secondary clerver 611 of device B 605 communicates equivalent information to the master clerver 607 of device B 605.

FIG. 22c indicates what happens when the secondary clerver 609 of device A 601 wishes to contact the clervers on device B 605. Clerver 609 of device A 601 knows which socket the master clerver 607 of device B 605 uses. Thus, clerver 609 contacts master clerver 607 on this—the appropriate—socket. Master clerver 607 then either informs clerver 609 of the services offered by the other clervers on device B 605 or confirms whether or not a service required by clerver 609 is available from device B 605. Clerver 609 then directly contacts the secondary clerver 611 of device B 605 if it provides the required service. Similarly, if the secondary clerver 611 of device B 605 wishes to contact the clervers of device A 601, it first contacts the master clerver 603 to obtain socket and service information of the clervers running on device A 601.

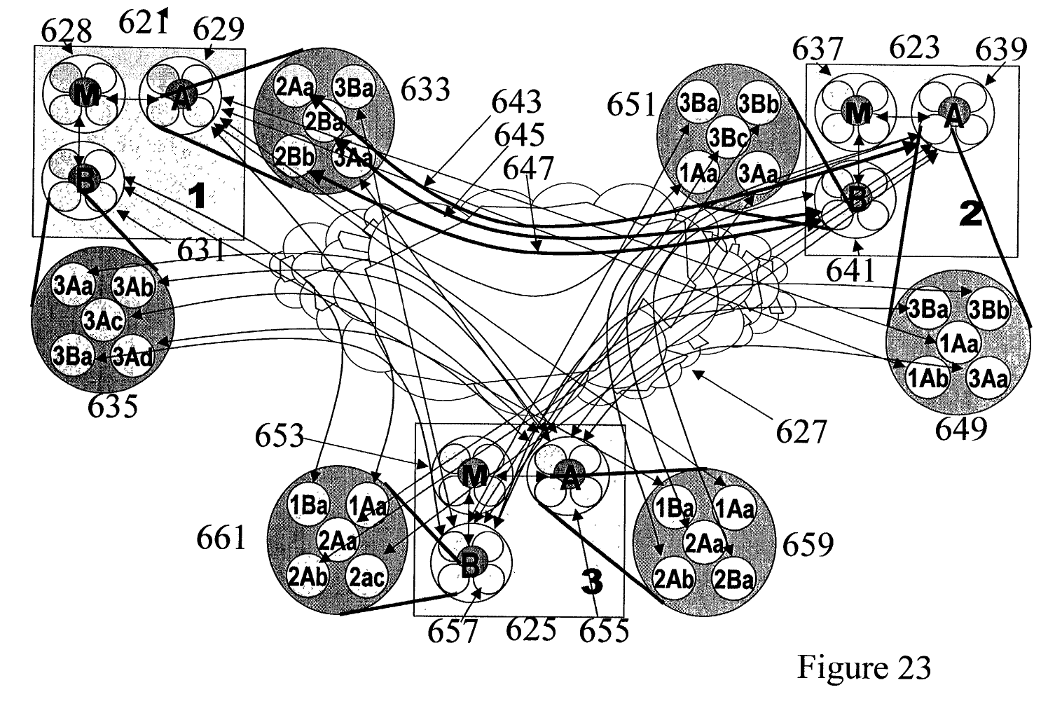

FIG. 23 shows three devices 621, 623 and 625 networked across a network 627 which could include the internet. Device 621 has a master clerver 628, secondary clerver A 629 and secondary clerver B 631. As previously mentioned with reference to FIG. 9, each clerver has an object management module which manages living objects stored in the memory. The part of the memory controlled by clerver 629 which stores living objects is schematically shown as memory area 633. The part of the memory which is controlled by clerver B 631 and stores living objects is shown schematically as area 635. Memory areas 633 and 635 store living objects owned by clervers on machines 623 and 625 and represent services between the clervers of device 621 and those of devices 623 and 625.

For example, considering device 623, the device has a master clerver 637 and secondary clervers 639 and 641. When clerver 639 of device 623 wishes to use the services of device 621, it first contacts the master clerver 628 of device 621 (see for example FIG. 22c). In this specific example, the services which clerver 639 of device 623 wishes to use are those provided by the clerver 629 of device 621. Clerver 639 of device 623 registers with clerver 629 of device 621 and a living object 2Aa is created in memory area 633 which is managed by clerver 629. This living object is actually owned by clerver 639 and requires a “heartbeat” of clerver 639 in order to remain alive. The ownership is indicated by heavy line 643. Similarly, when clerver 641 of device 623 wishes to use the services of device 621, it contacts master clerver 628 of device 621. When it is decided that the services of clerver 629 are required, then clerver 641 registers with clerver 629 and further living objects are set up in memory area 633. The living objects owned by clerver 641 are denoted as 2Ba and 2Bb. These living objects are owned by clerver 641 and heavy lines 645 and 647 respectively indicate the ownership. As shown in the FIG. 23, a remote clerver can own a number of living objects managed by the same clerver, i.e. have multiple parallel virtual sessions with the same clerver.

Similarly, clervers 639 and 641 of device 623 can register with clerver 631 of device 621 and living objects corresponding to these registrations and further operations are stored in memory area 635. Clervers 639 and 641 manage their own respective memory areas 649 and 651 respectively where living objects corresponding to registrations and other operations requested by clervers 629 and 631 of device 621 are stored.

Any number of clervers or devices containing such clervers can be networked together. In FIG. 23, device 625 also has a master clerver 653 and two secondary clervers 655 and 657. Each secondary clerver manages its own memory area 659 and 661 respectively. Clervers 657 and 655 can register and perform virtual sessions with the clervers of devices 621 and 623 and can also store living objects owned by the clervers of devices 621 and 623. Thus, it is possible for each clerver to be managing a plurality of living objects belonging to a plurality of different clervers split between different machines. In FIG. 23, the network of lines running from the living objects to the clervers indicate the ownership of the living objects and hence the virtual sessions formed between the clervers.

As discussed in FIGS. 22 and 23, the master clerver is primarily used as a discovery service which indicates to external clervers the type of clervers which are available in the machine and also the socket numbers for communicating with these clervers.

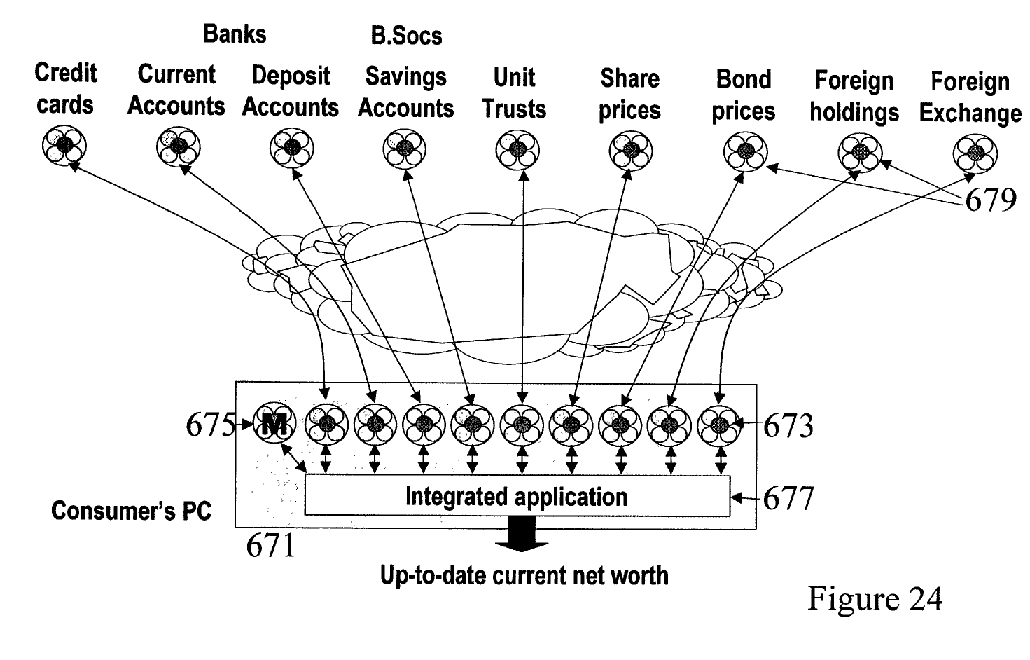

In FIG. 24, the user has a machine, which in this case is a simple Personal Computer (PC) 671 (but could be any computer or computing device including a mobile or PDA) which comprises a plurality of clervers 673 controlled by a master clerver 675. The application interface of each of the plurality of clervers 673 and the master clerver 675 interfaces to a single integrated application 677. In this particular example, the integrated application is a financial management application which is capable of bringing together up-to-date financial data concerning the user from across the internet, although deployment of this approach is not restricted to any particular type of application or network.

In this example, the user has a plurality of financial assets, e.g. credit cards, current accounts, deposit accounts, savings accounts, unit trusts, shares, bonds, foreign holdings and foreign currencies. Details of each of these assets are not kept in the same place. For example, the current account and deposit account will be on a bank's computers though not necessarily owned by the same bank; details of the share prices of his shares will be stored somewhere else.

In the example of FIG. 24, the user's PC runs 9 separate clervers 673. The services managed by each of these clervers is known to the master clerver 675. The service provider which relates to each type of financial asset owned by the user will also run a clerver. These clervers may be running on separate machines or may be running on the same machine, for example, where the user has multiple accounts at a bank. Each individual clerver-clerver session may have its own security, socket and encryption parameters and arrangements. As required by applications, each clerver-clerver session may be part of a wider virtual private network involving other devices, each virtual private network being itself totally unknown to the others.

Each of these service provider clervers is contacted by clerver 673 of the user's machine 671 in order to obtain up-to-date information concerning the status of each of the user's financial assets. This data is then passed to the integrated application 677 such that the user's PC 671 can display at the same time all of the information relating to the user's financial assets. The parallel nature of the multiple clerver sessions permit the user's view of his financial information to be updated in real time.

As has been discussed in relation to FIG. 11, clervers support different modes of transactions, including a one-to-many transaction mode known as ‘publish and subscribe’. This refers to many devices listening over a network for data being made available by a single device subject to authentication and authority levels. Publish and subscribe is a well-established technique in corporate or enterprise networks where authentication and authority levels are under proprietary control. However, it has not been possible to adapt publish and subscribe software satisfactorily to internet technologies because, although in a sense all web transactions are publish and subscribe, they are entirely open. It has not been possible to provide within internet technologies effective inbuilt authentication and management of authorities. This means that it is hard to make data sitting on legacy equipment directly available to authorised devices across the internet, the web or mobile networks.

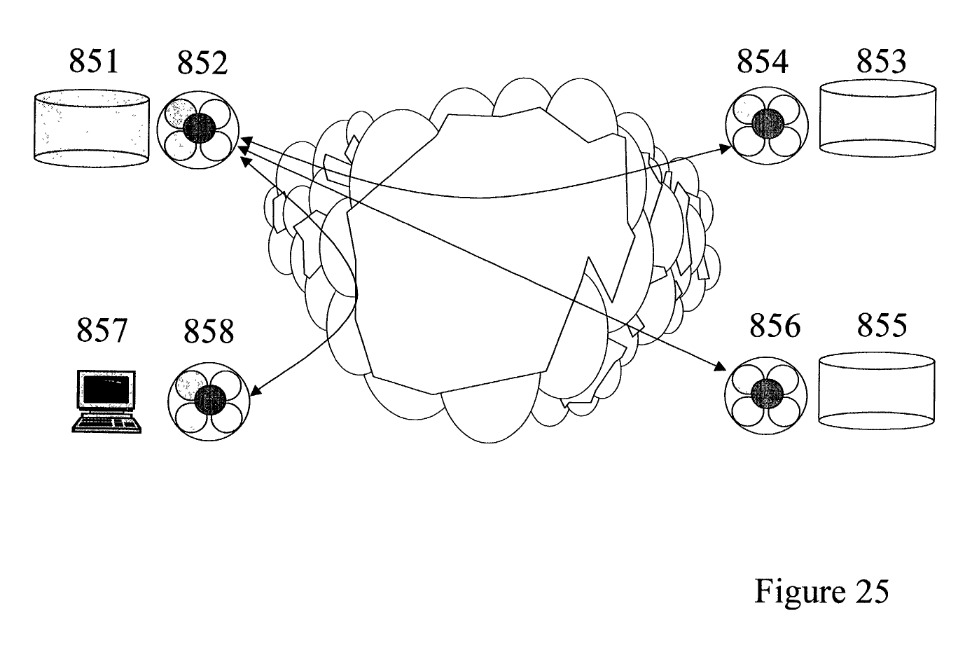

In the example outlined in FIG. 25, legacy devices, 851, 853, 855 are equipped with clervers 852, 854 and 856 respectively. The clervers communicate with each other and with other authorised clervers not attached to legacy equipment, shown as device 857 and clerver 858 across the internet or mobile or other network. Clervers 854, 856 and 858 can subscribe to data made available—‘published’—by the legacy application 851 via clerver 852 across the internet, an intranet, an extranet, mobile or other network. Authentication and management of authorities will be handled by the clervers as required by the application. Interactions between the systems 851, 853, 855 and 857 will be within an effective virtual private network and secure in the same manner as on an enterprise network. In this manner clervers enable legacy publish and subscribe configurations to be updated and integrated into new internet-based ecommerce trading networks without forcing radical and expensive re-equipment to be undertaken.

The advantages which Clervers provide in secure file transfers and the real-time tracking of operations have been previously described. These provide a perfect platform for leasing content such as digital audio and music, digital text, digital video, digital animation, digital software etc.

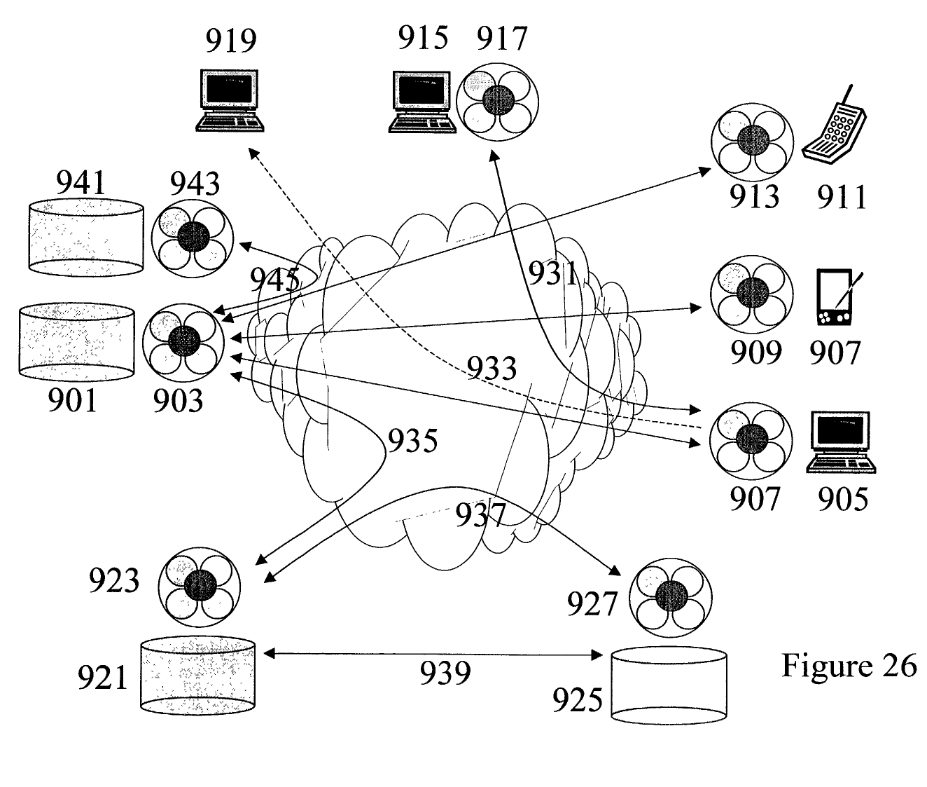

FIG. 26 illustrates a system for supporting such functions. The example will be explained with reference to pay-per-view digital video. However, it could be applied to any entity where the provider wants to restrict access to the entity.

In FIG. 26, a pay-per-view service provider 901 has clerver 903 which manages the pay-per-view operations. Consumer 905 wishes to lease digital video from pay per view service provider 901. The consumer 905 uses a PC to connect to the service provider's site 901 and registers with the service provider's 901 software. Depending on how payment is designed, the consumer's name may be validated against a credit card number. Once connected and registered, consumer 905 selects the content in which he is interested. Consumer 905 requests and specifies the type and number of devices with which he wishes to view or use the video. For example, he may specify other devices he owns or to which he has exclusive access, such as a hand-held device 907, a mobile 911, a laptop, other PCs or other network devices.

At a point during the registration process, the service provider's clerver 903 downloads a master clerver (as explained with reference to FIGS. 22 and 23) and a secondary clerver 907 to the device 905 from which the user is registering. Clervers 903 and 907 synchronise.

The service provider's clerver 903 creates a data structure which will be called a ‘Content Encryption Licence’ This comprises a UsernD, a maximum usage licence and/or a maximum period of usage time licence.

The UsernD comprises the HostID of the user's device 905, the clerver ID of the user's clerver 907, an ID for each item of content (in this example each video) selected, the date/time and the name of the user as registered and validated with the site initially.

The maximum usage licence is a figure denoting the maximum number of times each item of content can be utilised or played. The maximum period of usage time is a figure denoting the maximum length of time during which the selected items of content can be utilised or played, particularly relevant if there is a subscription model of payment of this example. An alternative configuration could be implemented whereby the user's clerver 907 builds the Content Encryption Licence and supplies it to the content provider's clerver 903.

The content provider's clerver 903 then builds a file containing digital copies of the selected content along with a Content Encryption Licence and a Content Encryption Meter. The Content Encryption Meter comprises mechanisms to enable usage of the content to be counted, the period of time from the start of the Content Encryption Licence to be calculated, the time of access and the user ID (thereby ensuring that measurements of content usage are irrevocably tied to the same digital entity as the identity that created the usage).

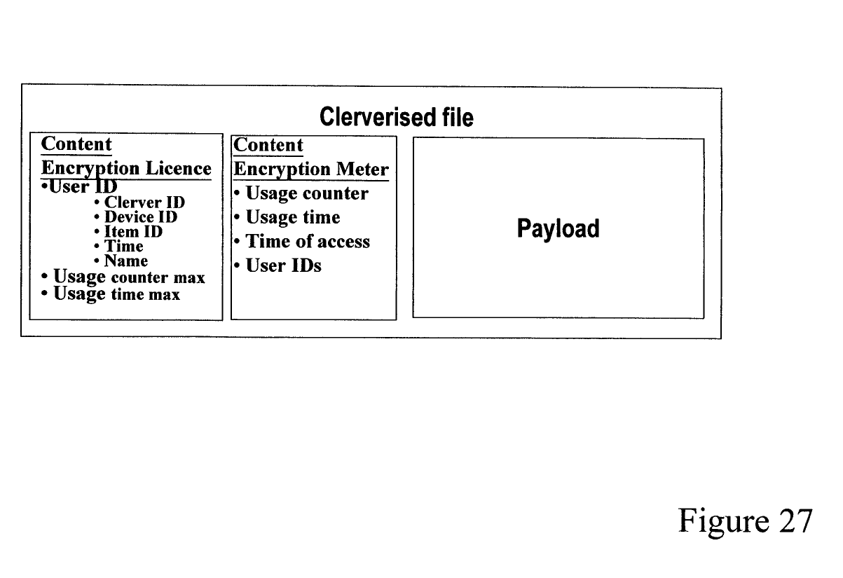

FIG. 27 illustrates the structure of this file which is constructed as a single entity with all device, clerver, content, rights and other licence information encapsulated within it. The entire file is encrypted. Individual elements within the file may be the subject of additional specific encryption. The content payload (the actual intellectual property the user wishes to use or view) will be encrypted with the Content Encryption Licence and only the user's clerver 907 in FIG. 26 will be able to access and update the Content Encryption Meter. Encryption can be designed to be unique to that file so that two users selecting the same content for the same period and for the same sort of device would receive the same selected content differently encrypted.

Once built, the file can be held at the content provider's site 901 and the content payload streamed to the user's clerver 907, or it can be held on the user's device 905. Or the construction of the file could take place in such a manner that the content payload section and/or other sections of the file could be held on the user's device 905 and the remainder on the content provider's machine 901, or vice versa. This is an example of the flexible way in which clervers can support a truly distributed application in which tightly coupled components of a uniquely encrypted entity can run in different interacting machines as business circumstances require. In the remainder of this example, it will be assumed that the Content Encryption Licence and the Content Encryption Meter will both run in their entirety on the user's clerver 907; but the example is non-limiting in that other processes dependent on an alternative configuration as mentioned above would also be possible.

The content provider's clerver 903 downloads the specially-constructed file to the user's clerver 907. On receiving the file, the user will be able to copy the file multiple times to supply it to other people 931 and 933 who have devices equipped with clervers (as with 915 and 917) or without clervers 919. But no device will be able to decrypt the file and view or use the content because it will not have the correct IDs. In the case of devices 915 with clervers 917, at least the HostID, the clerver ID, and the date/time will not match. In the case of devices without a clerver 919, there will be no clerver with which to recognise the encrypted file. Viewing and usage of the file will be entirely restricted to the device 905 which was the subject of the initial authorised synchronisation of clervers 903 and 907.

If attempts to ‘crack’ the encryption were made, each attempt will have to start from scratch on each new file because each encryption will be randomly different. No one security breach of a file will jeopardise any other file or content being breached. A person seeking to breach the security of the file by subverting the user's clerver 907 and seeking to instruct it to reassemble the file in a non-jumbled order would be unable to do so because the clerver 907 itself would be compiled code and itself encrypted and unresolvable.

Once the user 905 has received the file, the user may view or use the content as frequently or under the conditions permitted by the Content Encryption Licence. On each viewing or use, the user's clerver 907 increments the usage counter in the Content Encryption Meter and informs the content provider's clerver 903 of the incremented figure. Alternatively the Content Encryption Meter may be held at the content provider's clerver 903 and is updated accordingly by the user's clerver 907.

When the usage counter in the Content Encryption Meter exceeds the permitted number of views or uses in the Content Encryption Licence and/or exceeds the maximum permitted period of time in the Content Encryption Licence, the clerver holding the Content Encryption Meter, in our example 907, informs the user 905 that additional payment has to be made and prevents further usage. The running status of the Content Encryption Meter may be displayed at all times within the application to the user as an early warning.

If the user specified a number of additional devices 907 and 91 1 on which the content was to be viewed or used, on the first time of using each additional machine 907 and 911 for the purpose of viewing or using the selected content, the content provider's clerver 903 downloads a clerver 909, 913 to the additional devices 907, 911 respectively. In this example, each device's clerver 909, 913 increments its usage counter for that device 907 and 911 respectively. The devices'clervers 909 and 913 inform the content provider's clerver 903 of usage so that a usage counter at the content provider 901 is incremented accurately and consolidates multiple device usage. This consolidated status can of course be communicated to any other clerver on an authorised device.

If the content provider is not the owner of the content but has licensed the content for distribution or other purposes, the content provider may configure his system so that his clerver 903 may notify the clerver 943 of the ultimate owner 941 at the time of purchase by the user 905, or each time the content provider's clerver 903 is notified of a viewing by a device clerver 907, 909, 913, or after completion or expiry of a purchased period or any combination of such circumstances.

The content provider's clerver 903 triggers a payment to an online credit/debit card company 925, possibly via a payment services provider 921, either at the outset with the purchase of a subscription period, a specified number of views, or a purchased period of time, or after a specified number of ‘free’ views or uses, or on completion of the purchase agreement. The payment would be treated like any other credit/debit card payment and may involve clervers 923 and 927 as described elsewhere.

The content provider's clerver 903 may email user 905 with itemised audit of all uses by selected item, specified device, date and time or other criteria either at predetermined periods, on request by the user, or on completion of purchased period or purchased views.

1. A host for executing an operation requested by a requestor, the host comprising a memory configured to store information identifying the requestor and information related to the operation requested by the requestor, and processing means for determining the presence of the requestor and for freeing resources associated with that operation if the requestor is not present.

2. The host of claim 1, wherein the said memory stores information identifying the requestor as an object, wherein said processing means is configured to call a destructor to destroy the object unless a refresh signal is received within a predetermined time from the requestor.

3. The host of claim 2, wherein the host comprises means to send a signal to the requestor confirming receipt of the refresh signal.

4. The host of claim 2, wherein said memory is arranged to store a plurality of objects corresponding to a plurality of operations requested by the requestor, each object being linked to an object corresponding to a registration request from the requestor.

5. The host of claim 2, wherein the processing means is configured to execute operations requested by a plurality of requestors.

6. The host of claim 2, wherein the memory is configured to store an object corresponding to a registration request from each of the requestors and each subsequent operation requested by a requestor is linked to the object corresponding to its registration request.

7. The host of claim 4, wherein the processing means is adapted to free the resources associated with an object which is linked to an object corresponding to a registration request which has been deleted.

8. The host of claim 2, wherein an object comprises status information for allowing the status of the operation to be determined from the object.

9. The host of claim 2, wherein said memory is adapted to store an object for file open, read, write, seek and close operations.

10. The host of claim 2, wherein said memory is adapted to store an object for running a thread in the host.

11. The host of claim 2, wherein said processing means is adapted to send a signal to the requestor indicating the status of the operation, before the processing means calls a function to free resources associated with that object.

12. The host of claim 1, wherein the processing means is configured to store data concerning the status of the operation requested by the requestor which will remain in the memory of the host after the resources associated with the operator have been freed.

13. The host of claim 1, including connection means for connecting the host to another host via a network.

14. The host of claim 13, wherein said connection means is adapted for connection to a packet switched network.

15. The host of claim 14, wherein said connection means is adapted for connection to an asynchronous network.

16. A network comprising a first device connected to a second device across an asynchronous network, the first device being configured to execute an operation in response to a request from the second device to determine the presence of the second device and to free resources associated with the operator if the presence of the second device cannot be determined by the first device.

17. A method of executing an operation which is performed on a host remote from the requestor of the operation, the host and requestor being connected over an asynchronous network, the method comprising:
the requestor sending a signal to the host to request an operation to be performed by the host; and
the requestor intermittently sending a refresh signal from the requestor to the host in order to confirm that the requestor is still connected to the host.

18. The method of claim 17, wherein the requestor waits to receive a response from the remote host to indicate that the operation was successful.

19. The method of claim 18, wherein the requestor resends the signal requesting an operation if a response is not received within a predetermined time from the host.

20. The method of claim 17, wherein the requestor receives a signal from the host in response to sending a refresh signal.

21. The method of claim 20, wherein the requestor saves information relating to the status of the requested operation if no response is received from the host within a predetermined time.

22. The method of claim 17, wherein the requestor requests a registration operation with the host.

23. The method of claim 17, further comprising:
the requestor at least partially encrypting the request sent to the host.

24. The method of claim 23, wherein the requestor encrypts the request using information which uniquely identifies the requestor.

25. The method of claim 23, wherein the requestor encrypts the request using information which identifies an application running on the requestor which requires the request to be sent to the host.

26. The method of claim 23, wherein the requestor encrypts the request using the time when the request is encrypted.

27. The method of claim 23, wherein the requestor sends information to the host which will allow the host to decrypt the request with the encrypted request.

28. The method of claim 17, wherein the requestor sends its http address to the host.

29. A method of performing an operation in a host in response to a request from a requestor, the method comprising:
the host receiving a request from the requestor to perform an operation at the host;
storing information corresponding to the identity of the requestor at the host in the form of an object; and
freeing resources associated with that object if a refresh signal is not received by said host after a predetermined time.

30. The method of claim 29, wherein the host sends a signal concerning the status of the operation to the requestor if a refresh signal is not received within a predetermined time.

31. The method of claim 29, wherein the host stores data concerning the status of the operation which will remain after the resources associated with the operation have been freed.

32. The method of claim 29, wherein the host receives a registration request from the second device.

33. The method of claim 32, wherein the host decrypts the registration request and sends a signal to the requestor to indicate if the request has been successfully decrypted.

34. The method of claim 33, wherein the host uses information received from the host to decrypt the request.

35. The method of claim 33, wherein the host uses information which can be used to uniquely identify the host to decrypt the request.

36. The method of claim 33, wherein the host uses information which can be used to identify an application running on the requestor to decrypt the request.

37. The method of claim 33, wherein the host uses the current time the request was sent from the requestor to decrypt the request.

38. A host for executing a plurality of tasks in response to at least one request from a requestor, the host comprising a memory configured to store information identifying the requestor and information concerning the tasks such that information concerning the tasks can be preserved between tasks.

39. The host of claim 38, wherein information concerning the identity of the requestor is stored in the form of a registration object in the memory of the host and wherein status information concerning each of the tasks is also stored in the form of objects in the memory of the host.

40. The host of claim 39, wherein the host comprises processing means configured to free resources associated with an object if the host does not receive a refresh signal from the requestor within a predetermined time.

41. The host of claim 40, wherein the processing means is configured to delete a registration object if a refresh signal is not received in time.

42. The host of claim 41, wherein the memory is configured to store each of the objects relating to tasks requested by a requestor linked to the registration object of that requestor, the processing means being configured to free the resources associated with each of the tasks requested by the requestor upon deletion of the registration object.

43. A network comprising a first device connected to a second device across an asynchronous network, the first device being configured to execute a plurality of operations in response to a request from the second device to determine the presence of the second device and to delete the operations and free resources if the presence of the second device cannot be determined by the first device.

44. A device configured to retrieve data from at least one second device and to output said data, the device being configured to intermittently check for the presence of the second device such that the device can determine if data can be retrieved from the second device.

45. The device of claim 44, wherein the device comprises a web server and is configured to publish data from the second device in the form of web pages.

46. The device of claim 45, configured to indicate that web pages formed from information from the second device are only available if the first device determines that the second device is present.

47. The device of claim 44, wherein the device includes storage means for storing a flag which indicates if the second device is present, and means for setting said flag to indicate that the second device is not present if a signal is not received from the second device within a pre-determined time.

48. A device configured to receive information from at least one second device, wherein the device includes storage means for storing a flag which indicates if at least one of the other second devices is present, and means for determining if the second device is capable of sending information.

49. A code module for controlling a local processor connected to one or more remote processors controlled by like code modules over a network, the code module being adapted to control the processor to communicate with a remote processor and to save information concerning a session formed between the local and remote processors.

50. The code module of claim 49, adapted to control the local processor to save information identifying the code module of a remote processor with which it has formed a session in the form of a registration object.

51. The code module of claim 50, adapted to control the local processor to delete the object and free the resources associated with that object once the session is finished.

52. The code module of claim 51, wherein the object requires a signal from the code module of the remote processor after a predetermined time otherwise the session is finished.

53. The code module of claim 49, adapted to control the local processor to manage a plurality of tasks requested by the remote code module in a single session and to store information concerning the tasks requested in a single session such that information from previously performed tasks is available for use by later tasks requested in the same session.

54. The code module of claim 49, adapted to control the local processor to store information related to each requested task in the form of an object, wherein each object associated with a task is linked to the registration object.

55. The code module of claim 54, adapted to control the local processor to store the object relating to a task until the registration object has been deleted even if the task has been completed.

56. The code module of claim 54, adapted to control the local processor to delete an object associated with a task if the registration object to which it is linked has been or is going to be deleted.

57. The code module of claim 49, adapted to control the local processor to send a signal to the remote processor confirming that the session is to be terminated prior to terminating the session.

58. The code module of claim 49, adapted to control the local processor to store status information after the session has been terminated.

59. The code module of claim 58, adapted to control the local processor to set a flag to indicate whether or not status information should be stored in the event that the session is terminated.

60. The code module of claim 49, adapted to control the local processor to store a plurality of registration objects each associated with a different remote code module.

61. The code module of claim 60, adapted to control the local processor to link each of the objects relating to a task requested by a remote code module with the registration object of that control module.

62. The code module of claim 49, adapted to control the local processor to send information requesting a session with a remote processor which is managed by a similar code module.

63. The code module of claim 62, adapted to control the local processor to send information uniquely identifying the processor which is controlled by the code module to the remote processor when requesting a session.

64. The code module of claim 62, adapted to control the local processor to send information identifying itself to the remote processor when requesting a session.

65. The code module of claim 62, adapted to control the local processor to repetitively send a refresh signal to the remote processor to prevent the remote processor from ending the session.

66. The code module of claim 49, adapted to control the local processor to store status information relating to a requested task a signal is received indicating that the session formed with the remote processor is about to be terminated by the remote processor.

67. The code module of claim 49, wherein the code module is adapted to interface with an application which commands the code module to instruct tasks on a remote processor.

68. The code module of claim 67, adapted to interface with an application which can perform client and/or server functions

69. The code module of claim 49, wherein the code module is adapted to interface to an encryption package which can encrypt or decrypt signals received from the code module.

70. The code module of claim 49, wherein the code module is adapted to control the local processor to encrypt signals sent from said code module to a remote processor and decrypt signals received from a remote processor.

71. The code module of claim 69, wherein the code module is adapted to control the local processor to encrypt the signals using information which uniquely identifies the local processor.

72. The code module of claim 69, wherein the code module is adapted to control the local processor to encrypt the signals using information identifying the code module.

73. The code module of claim 69, wherein the code module is adapted to control the local processor to encrypt the signals using a time relating to when an operation was controlled by the code module.

74. The code module of claim 49, wherein the code module is adapted to directly interface to the socket layer of the processor.

75. The code module of claim 74, adapted to control the local processor to switch sockets during a session.

76. The code module of claim 49, adapted to control the local processor to publish pages to the internet.

77. The code module of claim 49, further comprising a user interface.

78. The code module of claim 77, wherein the user interface comprises a webserver.

79. The code module of claim 49, adapted to control the local processor to store information about a plurality of further code modules all adapted to control the same processor.

80. The code module of claim 49, adapted to control the local processor to store the socket numbers used by each of the plurality of further code modules.

81. The code module of claim 79, adapted to control the local processor to store information for each of the further plurality of code modules concerning the applications which are interfaces to each of the plurality of further code modules.

82. The code module of claim 79, adapted to interface to the same application as at least one of the further plurality of code modules.

83. A primary code module for controlling a processor to store information concerning at least one secondary code module wherein the at least one secondary code module is adapted to interface to a predetermined application and to manage a session formed between said processor and a remote processor.

84. The primary code module of claim 83, adapted to control the local processor to store information concerning the socket used by the at least one secondary module.

85. The primary code module of claim 83, adapted to control the local processor to store information concerning the services which can be provided by said at least one secondary code module by virtue of the application to which it is attached.

86. The primary code module of claim 83, adapted to control the local processor to store information concerning a plurality of secondary code modules interfaced to a plurality of applications.

87. The primary code module of claim 83, adapted to control the local processor to store information concerning a plurality of secondary code modules interfaced to the same application.

88. The primary code module of claim 83, adapted to interface to an application.

89. The primary code module of claim 88, adapted to interface to the same application as at least one of the secondary code modules.

90. The primary code module of claim 83, adapted to control the local processor to listen on a predetermined socket which is known to all other authorised processors which are networked to the said processor.

91. The primary code module of claim 90, adapted to control the local processor to send said information in response to an enquiry from a remote processor such that said remote code module can contact one of the secondary code modules controlling said processor.

92. The code module of claim 49, adapted to be downloaded from a first device to a second device.

93. The code module of claim 92, adapted such that it can be downloaded by a second device which does not have such a code module.

94. A carrier medium carrying the processor readable code module in accordance with claim 49.

95. A plurality of devices each comprising a code module in accordance with claim 49.

96. The plurality of devices of claim 95, wherein each of the code modules is adapted to interface with an application which operates as a client and/or a server.

97. A method of sharing data files between a number of devices, the files being stored in a distributed manner amongst any number of the devices, wherein metadata containing at least the location of the files provided to be read by any of the devices with the appropriate access rights.

98. The method according of claim 97, wherein the metadata is stored on all of the devices.

99. The method of claim 97, wherein the metadata is stored on a registry device which does not store the shared files.

100. The method of claim 99, wherein each of the devices which can store a file registers information including at least the location of the file with the registry.

101. The method of claim 99, wherein the registry stores information concerning the attributes of the different types of files.

102. The method of claim 97, wherein the registry comprises processing means to distinguish between files with different attributes such that the registry can supply information concerning the just files with a specific attribute.

103. The method of claim 102, wherein the files relate to advertisements, the registry storing the information concerning the type of advertisement as well as its location, the registry also being able to distinguish between different types of advertisements such that the locations of advertisements of the same type can be retained in response to an enquiry requesting a certain type of advertisement.

104. The method of claim 102, wherein an enquiry is sent to the registry from a remote device requesting files having certain attributes and wherein the location of each of the files with the requested attributes is sent to the remote device.

105. The method of claim 102, wherein an enquiry is sent to the registry from a remote device requesting files having certain attributes and wherein the registry contacts each of devices where files are located with the requested attributes and these files are sent to the remote device.

106. The method of claim 97, wherein each of the devices comprises a code module in accordance with claim 49, to manage the sessions formed between the devices.

107. A method of transferring files from a first device to a second device, the method comprising:
the first device interrogating a registry device with which the second device will register if it is able to receive the file;
the first device sending a request to register with said second device and to establish a session if the second device is able to receive the file; and
sending the file to the second device.

108. The method of claim 107, wherein the first device sends the file to the registry if the second device is not able to accept the file.

109. The method of claim 107, adapted to send e-mail from the first device to the second device.

110. The method of claim 107, wherein the first device and the second device each comprise a processor which is controlled by a code module in accordance with claim 49.

111. The method of claim 110, wherein the code module of the first device and the code module of the second device negotiate with one another to switch sockets during transfer of the file.

112. A method of transferring a file from a first device to a second device, wherein the first device subdivides the file to be transferred into portions and wherein the sockets are changed between the transmission of individual portions.

113. The method of claim 112, wherein each portion contains information which indicates the socket of the following portion.

114. The method of claim 111, wherein the first device subdivides the file into portions of different sizes.

115. The method of claim 112, wherein the first device and the second device each comprise a processor which is controlled by a code module in accordance with claim 49.

116. A communication method between a first device and a second device, comprising the steps of:
the second device receiving a registration request from the first device, the registration request comprising information uniquely identifying the first device.

117. The method of claim 116, farther comprising the step of the second device performing checks to see if the registration request came from a device to which the second device can provide services.

118. The method of claim 117, wherein the second device is adapted to perform a step in a sales transaction requested by the first device.

119. The method of claim 118, wherein the second device is adapted to refuse the transaction request of the first device, if the first device has been used in a previous fraudulent transaction.

120. The method of claim 116, wherein the first device and the second device each comprise a processor which is controlled by a code module in accordance with claim 49.

121. A plurality of devices connected over a common network, each device being able to access data files on at least one of the other devices, wherein at least one of the devices has a web server responsive to authorised access requests to output selected data files as webpages.

122. The plurality of devices of claim 121, wherein each device comprises a processor having a code module in accordance with claim 49.

123. A method of leasing file content to a remote device, the method comprising the steps of:
the lessor receiving a request from a remote device indicating that the device wishes to lease at least some file content,
the lessor receiving information identifying the file content to be leased, information uniquely identifying the device requesting the lease and indicating the required extent of the lease;
the lessor packaging the requested file content with information uniquely identifying the user and indicating the extent of the lease to form a packaged file; and
executing the packaged file such that the file content is delivered to the remote device.

124. The method of claim 123, wherein the requested file content is packaged with code which allow usage of the file by the remote device to be monitored by the lessor.

125. The method of claim 123, wherein the packaged file is encrypted.

126. The method of claim 123, wherein the packaged file is sent to the remote device and the remote device executes the packaged file.

127. The method of claim 123, wherein the packaged file is executed in a distributed manner between the lessor and the remote device.

128. The method of claim 127, wherein the file content is streamed to the remote device.

129. The method of claim 127, wherein the code which allow usage of the file by the remote device to be monitored by the lessor is executed remote from the remote device.

130. The method of claim 123, wherein the file is packaged with a user identifier, the user identifier comprising information which uniquely identifies the remote device, information which identifies the requested file content and information which identifies a code module running on the remote device which communicates with the lessor.

131. The method of claim 130, wherein the user identifier comprises temporal information.

132. The method of claim 123, further comprising the step of the lessor receiving a registration request from the user.

133. The method of claim 131, further comprising the step of the lessor receiving a registration request from the user.

134. The method according of claim 133, wherein the temporal information relates to the time and date when the user registered with the lessor.

135. The method of claim 132, wherein the lessor is provided with a code module in accordance with claim 49.

136. The method of claim 135, further comprising the lessor sending a code module to the remote device is response to receiving a registration request from the remote device.

137. The method of claim 123, further comprising the lessor receiving a request from the remote device to lease the file content to other devices.

138. The method of claim 137, further comprising the step of the lessor sending a code module in accordance with claim 49, to the other devices.

139. A host for executing an operation requested by a requestor, the host comprising a memory configured to store information identifying the requestor and information related to the operation requested by the requestor, and processing circuit for determining the presence of the requestor and for freeing resources associated with that operation if the requestor is not present.

140. A method of performing an operation in a host in response to a request from a requestor, the method comprising:
the host receiving a request from the requestor to perform an operation at the host;
the host storing information corresponding to the identity of the requestor at the host in the form of an object; and
the host freeing resources associated with that object if a refresh signal is not received by said host after a predetermined time.
